(19) United States
(12) Patent Application Publication
(10) Pub. No.: US 2017/0127060 A1
(43) Pub. Date: May 4, 2017

(54) MULTI-LAYER VIDEO ENCODING METHOD AND MULTI-LAYER VIDEO DECODING METHOD USING DEPTH BLOCKS

(71) Applicant: SAMSUNG ELECTRONICS CO., LTD., Suwon-si (KR)

(72) Inventors: Min-woo PARK, Yongin-si (KR); Jin-young LEE, Suwon-si (KR)

(73) Assignee: SAMSUNG ELECTRONICS CO., LTD., Suwon-si (KR)

(21) Appl. No.: 15/319,181

(22) PCT Filed: Jun. 9, 2015
(86) PCT No.: PCT/KR2015/005745

§ 371 Date: Dec. 15, 2016

Related U.S. Application Data
(60) Provisional application No. 62/013,688, filed on Jun. 18, 2014.

(51) Int. Cl. H04N 19/119; H04N 19/30; H04N 19/593; H04N 19/176

(52) U.S. Cl. CPC H04N 19/119; H04N 19/176; H04N 19/30; H04N 19/593

(57) ABSTRACT

Provided is a multilayer video decoding method including obtaining a disparity vector of a current block; and when a size of the current block is greater than a predetermined block size, splitting the current block into a plurality of regions, based on a depth block indicated by the disparity vector.

### TECHNICAL FIELD

The present disclosure relates to a multilayer video encoding method and a multilayer video decoding method.

### BACKGROUND ART

As hardware for reproducing and storing high resolution or high quality video content is being developed and supplied, a need for a video codec for effectively encoding or decoding the high resolution or high quality video content is increasing. According to a conventional video codec, a video is encoded according to a limited encoding method based on a macroblock having a predetermined size.

Image data of a spatial domain is transformed into coefficients of a frequency domain via frequency transformation. According to a video codec, an image is split into blocks having a predetermined size, discrete cosine transformation (DCT) is performed on each block, and frequency coefficients are encoded in block units, for rapid calculation of frequency transformation. Compared with image data of a spatial domain, coefficients of a frequency domain are easily compressed. In particular, since an image pixel value of a spatial domain is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

A multilayer video codec encodes and decodes a first layer video and at least one second layer video. Amounts of data of the first layer video and the second layer video may be reduced by removing temporal/spatial redundancy and layer redundancy of the first layer video and the second layer video.

### DETAILED DESCRIPTION OF THE INVENTION

### Technical Problem

The present disclosure provides efficient multilayer video encoding and decoding methods using type information of a layer.

### Technical Solution

According to an aspect of the present disclosure, there is provided a multilayer video decoding method including obtaining a disparity vector of a current block; and when a size of the current block is greater than a predetermined block size, splitting the current block into a plurality of regions, based on a region-split shape of a depth block indicated by the disparity vector.

The predetermined block size may be one of 4×4, 8×8, 16×16, 32×32, and 64×64.

### Advantageous Effects

According to the present disclosure, a multilayer video can be efficiently encoded and decoded by using type information of a layer.

### DESCRIPTION OF THE DRAWINGS

FIG. 1A is a block diagram of a multilayer video encoding apparatus, according to an embodiment.

FIG. 1B is a flowchart of a multilayer video encoding method, according to an embodiment.

FIG. 1C is a flowchart of a multilayer video encoding method, according to another embodiment.

FIG. 1D is a flowchart of a multilayer video encoding method, according to another embodiment.

FIG. 2A is a block diagram of a multilayer video decoding apparatus, according to an embodiment.

FIG. 2B is a flowchart of a multilayer video decoding method, according to an embodiment.

FIG. 2C is a flowchart of a multilayer video decoding method, according to another embodiment.

FIG. 2D is a flowchart of a multilayer video decoding method, according to another embodiment.

FIG. 3A is a diagram of an inter-layer prediction structure, according to an embodiment.

FIG. 3B illustrates a multilayer video according to an embodiment.

FIG. 4A is a diagram for describing a disparity vector of a current block, according to an embodiment.

FIG. 4B illustrates an example in which a disparity vector is obtained by using a spatially-neighboring block candidate of a current block, according to an embodiment.

FIG. 4C illustrates an example in which a disparity vector is obtained by using a temporally-neighboring block candidate of a current block, according to an embodiment.

FIG. 4D illustrates an example in which a disparity vector of a current block is obtained by using a depth picture, according to an embodiment.

FIG. 5 illustrates an example in which a current block is split by using a depth block corresponding to the current block, according to an embodiment.

FIG. 6 is a flowchart of a method of determining whether to perform a depth-based block partition (DBBP) function by taking into account a size of a current block, according to an embodiment.

FIG. 7A illustrates an example of syntax for determining whether to perform DBBP by taking into account a size of a current block, according to an embodiment.

FIG. 7B illustrates an example of syntax for determining whether to perform DBBP by taking into account a size of a current block, according to another embodiment.

FIG. 8A illustrates an example in which residual prediction is performed, according to an embodiment.

FIG. 8B illustrates an example in which residual prediction is performed, according to another embodiment.

FIG. 9 is a flowchart of a method of determining whether to perform residual prediction by taking into account a size of a current block, according to an embodiment.

FIG. 10 is a block diagram of a video encoding apparatus based on coding units according to a tree structure, according to an embodiment.

FIG. 11 is a block diagram of a video decoding apparatus based on coding units according to a tree structure, according to an embodiment.

FIG. 12 is a diagram for describing a concept of coding units, according to an embodiment.

FIG. 13 is a block diagram of an image encoder based on coding units, according to an embodiment.

FIG. 14 is a block diagram of an image decoder based on coding units, according to an embodiment.

FIG. 15 is a diagram illustrating coding units and partitions, according to an embodiment.

FIG. 16 is a diagram for describing a relationship between a coding unit and transformation units, according to an embodiment.

FIG. 17 illustrates a plurality of pieces of encoding information, according to an embodiment.

FIG. 18 is a diagram of deeper coding units according to depths, according to an embodiment.

FIGS. 19, 20, and 21 are diagrams for describing a relationship between coding units, prediction units, and transformation units, according to an embodiment.

FIG. 22 is a diagram for describing a relationship between a coding unit, a prediction unit, and a transformation unit, according to encoding mode information of Table 1.

FIG. 23 is a diagram of a physical structure of a disc in which a program is stored, according to an embodiment.

FIG. 24 is a diagram of a disc drive for recording and reading a program by using the disc.

FIG. 25 is a diagram of an overall structure of a content supply system for providing a content distribution service.

FIGS. 26 and 27 illustrate external and internal structures of a mobile phone to which the video encoding method and the video decoding method of the present disclosure are applied, according to embodiments.

FIG. 28 illustrates a digital broadcasting system employing a communication system, according to an embodiment.

FIG. 29 is a diagram illustrating a network structure of a cloud computing system using a video encoding apparatus and a video decoding apparatus, according to an embodiment.

### BEST MODE

According to a first aspect of the present disclosure, there is provided a multilayer video decoding method including obtaining a disparity vector of a current block; and when a size of the current block is greater than a predetermined block size, splitting the current block into a plurality of regions, based on a region-split shape of a depth block indicated by the disparity vector.

The predetermined block size may be one of 4×4, 8×8, 16×16, 32×32, and 64×64.

The splitting of the current block into the plurality of regions may include splitting the current block into subblocks of the current block, according to the shape by which the depth block is split into a plurality of subblocks.

According to a second aspect of the present disclosure, there is provided a multilayer video decoding method including determining one or more neighboring block candidates of a current block; obtaining a disparity vector of at least one block from among the determined one or more neighboring block candidates; determining the obtained disparity vector to be a disparity vector of the current block; determining a depth block corresponding to the current block by using the determined disparity vector; and splitting the current block into a plurality of regions, based on a region-split shape of the depth block.

According to a third aspect of the present disclosure, there is provided a multilayer video decoding method including obtaining a disparity vector of a current block; obtaining a residual component of a reference block indicated by the disparity vector of the current block; and when a size of the current block is greater than a predetermined size, predicting a residual component of the current block by using the obtained residual component of the reference block.

The predetermined size may be one of 4×4, 8×8, 16×16, 32×32, and 64×64.

According to a fourth aspect of the present disclosure, there is provided a multilayer video encoding method including obtaining a disparity vector of a current block; and when a size of the current block is greater than a predetermined block size, splitting the current block into a plurality of regions, based on a region-split shape of a depth block indicated by the disparity vector.

The predetermined block size may be one of 4×4, 8×8, 16×16, 32×32, and 64×64.

The splitting of the current block into the plurality of regions may include splitting the current block into subblocks of the current block, according to the shape by which the depth block is split into a plurality of subblocks.

According to a fifth aspect of the present disclosure, there is provided a multilayer video encoding method including determining a neighboring block candidate of a current block; obtaining a disparity vector of the determined neighboring block candidate; determining the obtained disparity vector to be a disparity vector of the current block; determining a depth block corresponding to the current block by using the determined disparity vector; and splitting the current block into a plurality of regions, based on a region-split shape of the depth block.

According to a sixth aspect of the present disclosure, there is provided a multilayer video encoding method including obtaining a disparity vector of a current block; obtaining a residual component of a reference block indicated by the disparity vector of the current block; and when a size of the current block is greater than a predetermined size, predicting a residual component of the current block by using the obtained residual component of the reference block.

The predetermined size may be one of 4×4, 8×8, 16×16, 32×32, and 64×64.

According to a seventh aspect of the present disclosure, there is provided a multilayer video decoding apparatus including a decoder configured to obtain a disparity vector of a current block, and when a size of the current block is greater than a predetermined block size, to split the current block into a plurality of regions, based on a region-split shape of a depth block indicated by the disparity vector.

The predetermined block size may be one of 4×4, 8×8, 16×16, 32×32, and 64×64.

The decoder may be further configured to split, when the decoder splits the current block into the plurality of regions, the current block into subblocks of the current block, according to the shape by which the depth block is split into a plurality of subblocks.

According to an eighth aspect of the present disclosure, there is provided a multilayer video encoding apparatus including an encoder configured to obtain a disparity vector of a current block, and when a size of the current block is greater than a predetermined block size, to split the current block into a plurality of regions, based on a region-split shape of a depth block indicated by the disparity vector.

The predetermined block size may be one of 4×4, 8×8, 16×16, 32×32, and 64×64.

The encoder may be further configured to split, when the encoder splits the current block into the plurality of regions, the current block into subblocks of the current block, according to the shape by which the depth block is split into a plurality of subblocks.

### MODE OF THE INVENTION

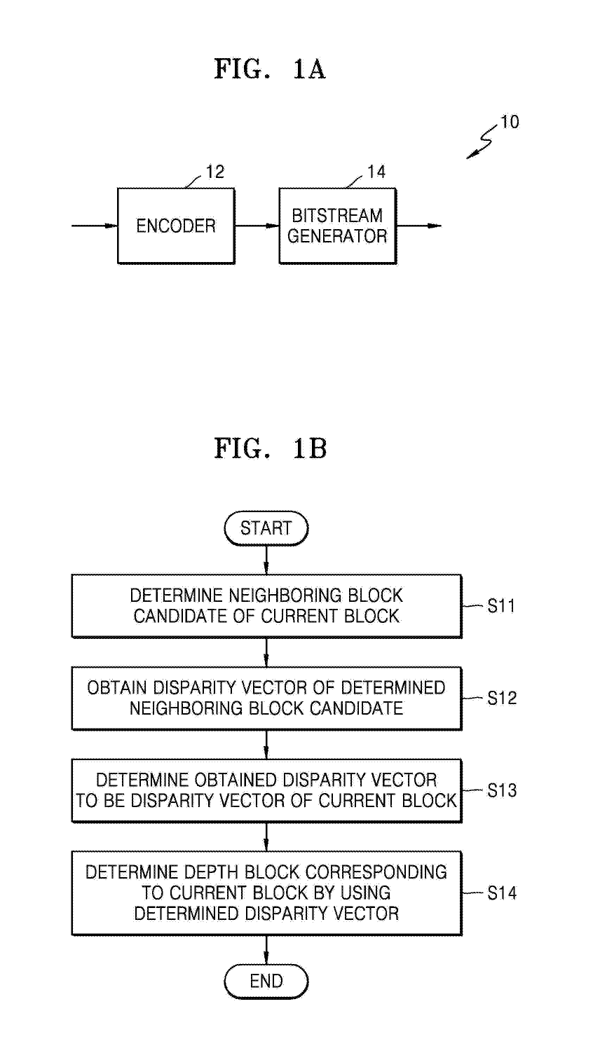

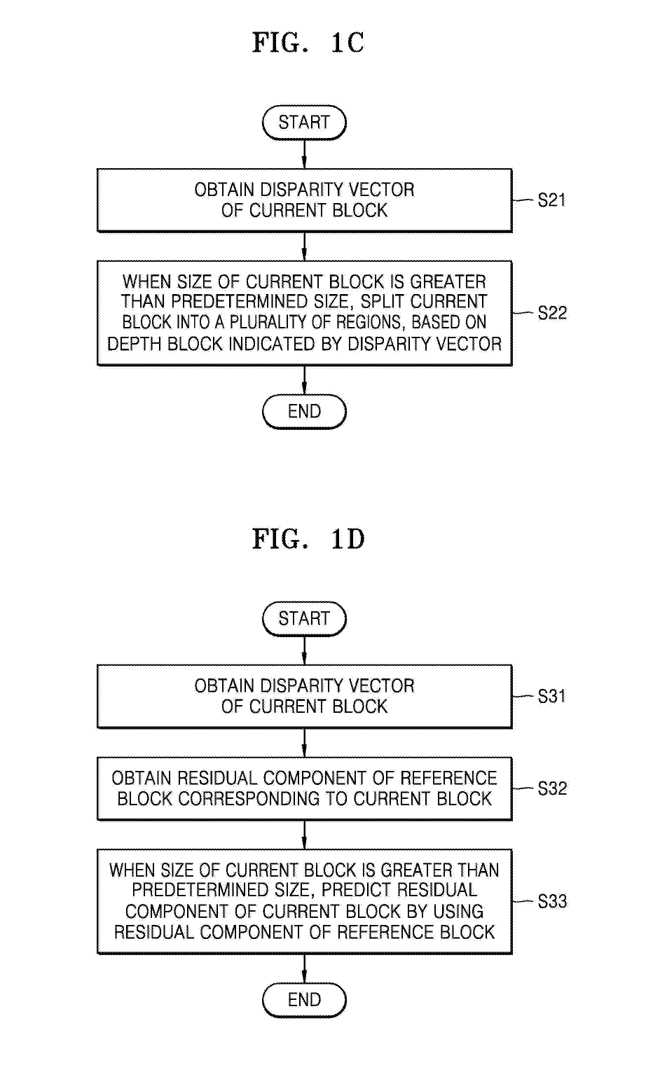

Hereinafter, with reference to FIGS. 1A through 9, a multilayer video encoding technique and multilayer video decoding technique using depth blocks according to an embodiment will be provided.

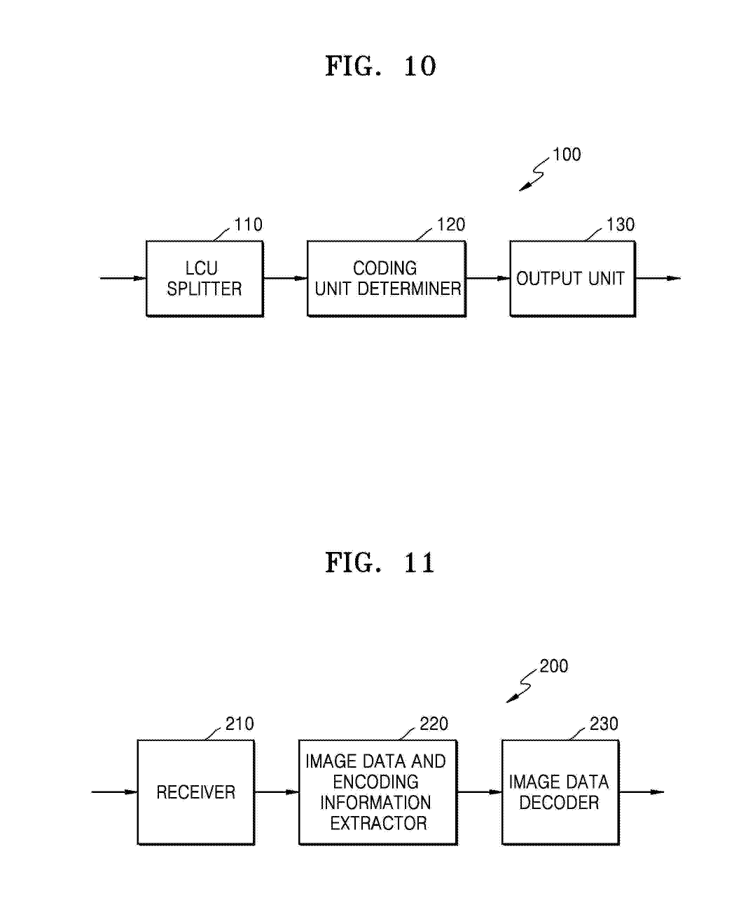

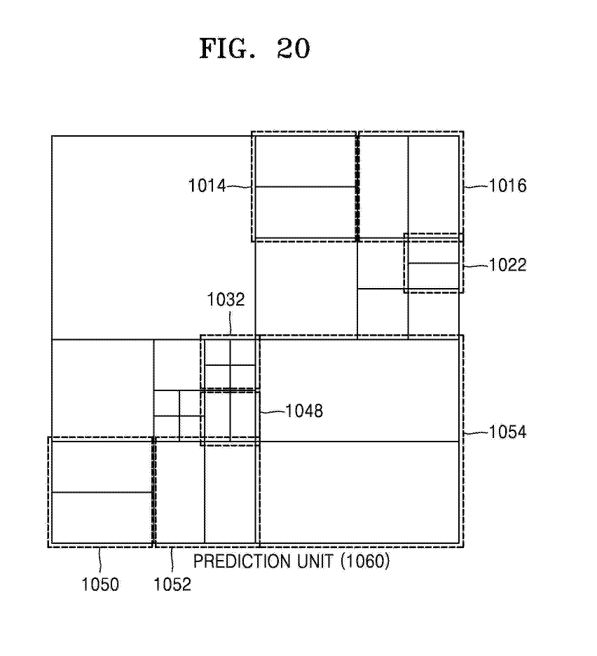

Also, with reference to FIGS. 10 through 22, a video encoding technique and video decoding technique based on coding units having a tree structure which are applicable to the multilayer video encoding and decoding techniques will be described.

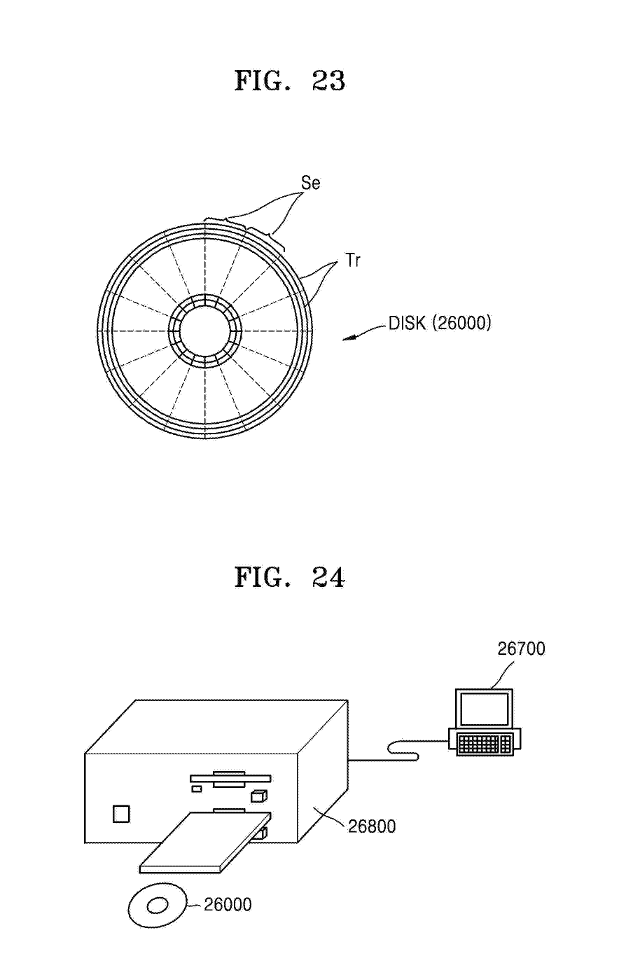

Also, with reference to FIGS. 23 through 29, embodiments to which the video encoding method and the video decoding method are applicable will be described.

Hereinafter, an ‘image’ may refer to a still image or a moving image of a video, or a video itself.

Hereinafter, a ‘sample’ refers to data that is assigned to a sampling location of an image and is to be processed. For example, pixels in an image of a spatial domain may be samples.

Hereinafter, a ‘current block’ may refer to a block of an image to be encoded or decoded.

Hereinafter, a ‘neighboring block candidate’ refers to at least one encoded or decoded block adjacent to the current block. For example, the neighboring block candidate may be located at the top, upper right, left, or upper left of the current block. Also, the neighboring block candidate may include a spatially-neighboring block or a temporally-neighboring block. For example, a temporally-neighboring block candidate may include a block of a reference picture, which is co-located with the current block, or a neighboring block of the co-located block.

Hereinafter, a “layer image” refers to images corresponding to a particular view or a same type. In a multiview video, one layer image refers to texture images or depth images which are input at a particular view. For example, in a three-dimensional (3D) video, a left-view texture image, a right-view texture image, and a depth image may respectively configure layer images. The left-view texture image may configure a first layer image, the right-view texture image may configure a second layer image, and the depth image may configure a third layer image.

FIG. 1A is a block diagram of a multilayer video encoding apparatus, according to an embodiment.

Referring to FIG. 1A, a multilayer video encoding apparatus 10 may include an encoder 12 and a bitstream generator 14.

The multilayer video encoding apparatus 10 according to an embodiment may classify and encode a plurality of image sequences according to layers, according to a scalable video coding scheme, and may output separate streams including encoded data according to the layers. The multilayer video encoding apparatus 10 may encode a first layer image sequence and a second layer image sequence to different layers.

For example, the encoder 12 may encode first layer images and may output a first layer stream including encoded data of the first layer images. Also, the encoder 12 may encode second layer images and may output a second layer stream including encoded data of the second layer images.

Also, for example, according to a scalable video coding scheme based on spatial scalability, low resolution images may be encoded as first layer images, and high resolution images may be encoded as second layer images. An encoding result of the first layer images may be output as a first layer stream, and an encoding result of the second layer images may be output as a second layer stream.

The multilayer video encoding apparatus 10 according to an embodiment may express and encode the first layer stream and the second layer stream as one bitstream through a multiplexer.

As another example, a multiview video may be encoded according to a scalable video coding scheme. Left-view images may be encoded as first layer images and right-view images may be encoded as second layer images.

Alternatively, central-view images, left-view images, and right-view images may be each encoded, wherein the central-view images are encoded as first layer images, the left-view images are encoded as second layer images, and the right-view images are encoded as third layer images. Alternatively, a central-view texture image, a central-view depth image, a left-view texture image, a left-view depth image, a right-view texture image, and a right-view depth image may be respectively encoded as a first layer image, a second layer image, a third layer image, a fourth layer image, a fifth layer image, and a sixth layer image.

As another example, a central-view texture image, a central-view depth image, a left-view depth image, a left-view texture image, a right-view depth image, and a right-view texture image may be respectively encoded as a first layer image, a second layer image, a third layer image, a fourth layer image, a fifth layer image, and a sixth layer image.

As another example, a scalable video coding method may be performed according to temporal hierarchical prediction based on temporal scalability. A first layer stream including encoding information generated by encoding base frame rate images may be output. Temporal levels may be classified according to frame rates and each temporal level may be encoded according to layers. A second layer stream including encoding information of a high frame rate may be output by further encoding higher frame rate images by referring to the base frame rate images.

Also, scalable video coding may be performed on a first layer and a plurality of extension layers (a second layer, a third layer, . . . , a K-th layer). When there are at least three extension layers, first layer images and K-th layer images may be encoded. Accordingly, an encoding result of the first layer images may be output as a first layer stream, and encoding results of the first, second, . . . , K-th layer images may be respectively output as first, second, . . . , K-th layer streams.

The multilayer video encoding apparatus 10 according to an embodiment may perform inter prediction in which images of a single layer are referenced in order to predict a current image. By performing the inter prediction, a motion vector between the current image and a reference image may be derived, and a residual component that is a disparity component between the current image and a prediction image generated by referring to the reference image may be generated.

Also, when the multilayer video encoding apparatus 10 according to an embodiment allows at least three layers, i.e., first through third layers, inter-layer prediction between a first layer image and a third layer image, and inter-layer prediction between a second layer image and a third layer image may be performed according to a multilayer prediction structure.

In interlayer prediction, when a view of a layer of a current image is different from a view of a layer of a reference image, a disparity vector between the current image and the reference image of the layer different from that of the current image may be derived, and a residual component that is a disparity component between the current image and a prediction image generated by using the reference image of the different layer may be generated. Here, a disparity vector may be referred to as a parallax vector.

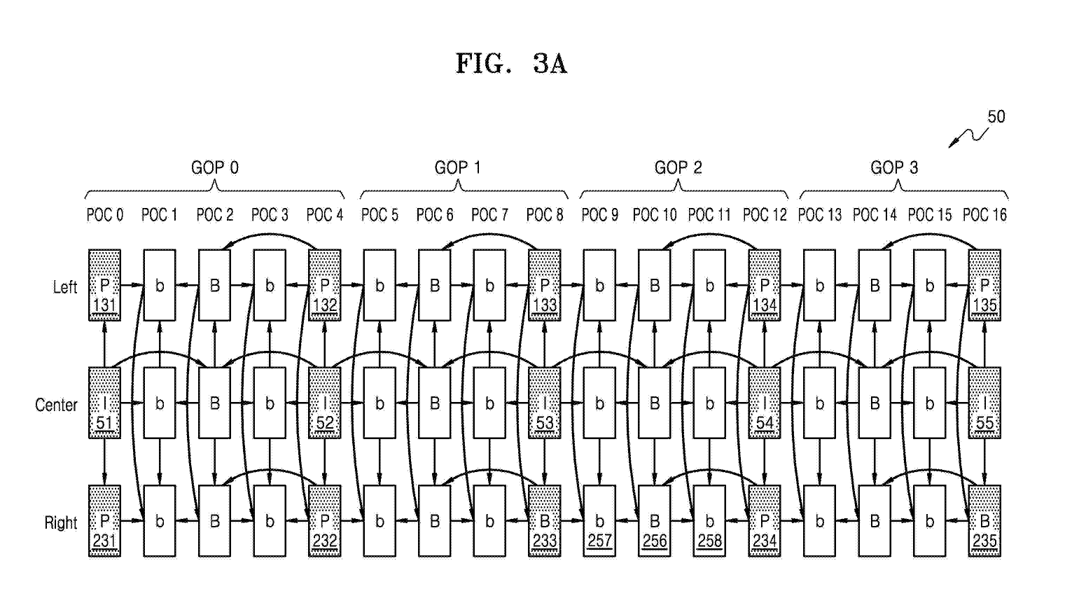

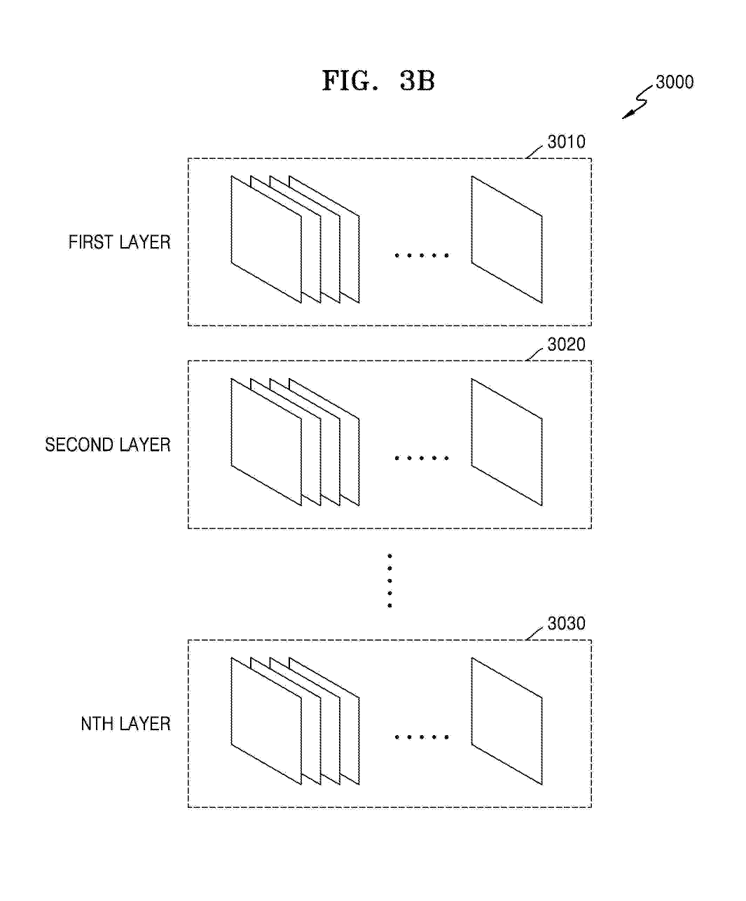

The inter-layer prediction structure will be described later with reference to FIG. 3A.

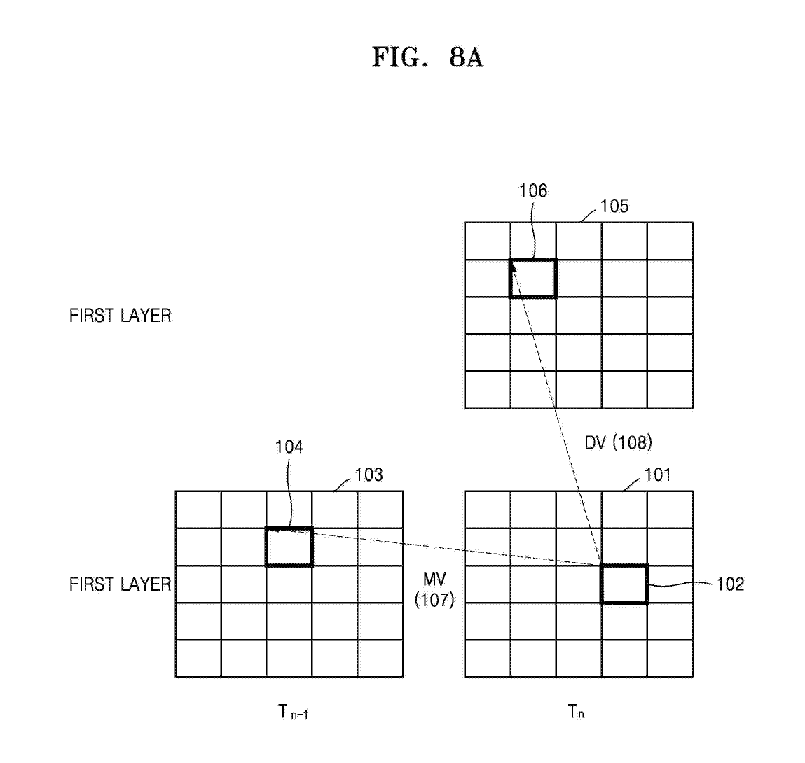

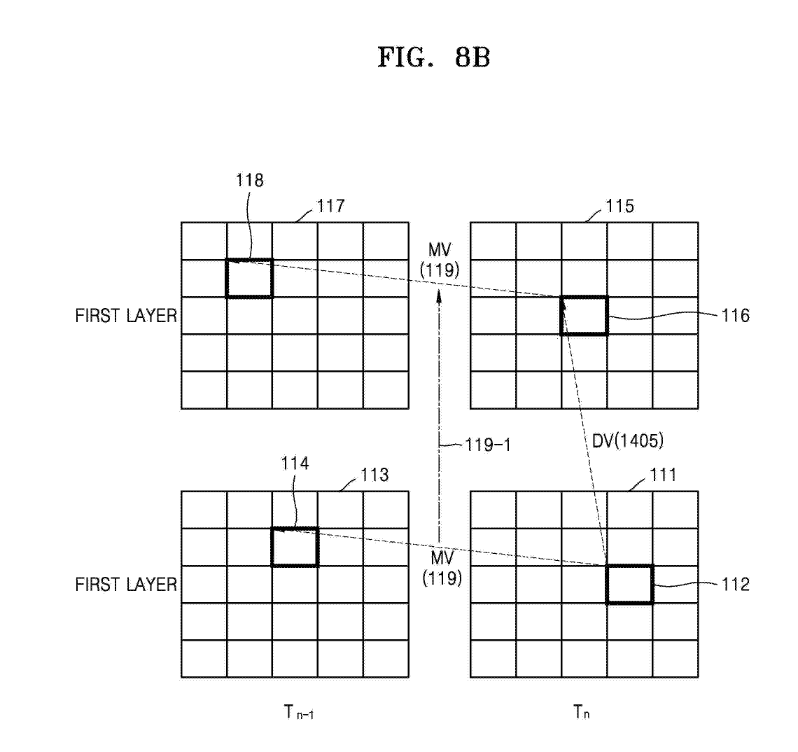

The multilayer video encoding apparatus 10 according to an embodiment may perform encoding according to blocks of each image of a video, according to layers. A block may have a square shape, a rectangular shape, or an arbitrary geometrical shape, and is not limited to a data unit having a predetermined size. The block may be a largest coding unit, a coding unit, a prediction unit, or a transformation unit, among coding units according to a tree structure. The largest coding unit including the coding units of a tree structure may be called differently, such as a coding tree unit, a coding block tree, a block tree, a root block tree, a coding tree, a coding root, or a tree trunk. Video encoding and decoding schemes based on the coding units according to a tree structure will be described later with reference to FIGS. 8 through 20.

Inter prediction and inter-layer prediction may be performed based on a data unit such as a coding unit, a prediction unit, or a transformation unit.

The encoder 12 according to an embodiment may generate symbol data by performing source coding operations including inter prediction or intra prediction on first layer images. The symbol data may include a value of each encoding parameter and a sample value of a residual.

For example, the encoder 12 may generate symbol data by performing inter prediction or intra prediction, transformation, and quantization on samples of a data unit of first layer images, and may generate a first layer stream by performing entropy encoding on the symbol data.

The encoder 12 may encode second layer images based on coding units of a tree structure. The encoder 12 may generate symbol data by performing inter/intra prediction, transformation, and quantization on samples of a coding unit of second layer images, and may generate a second layer stream by performing entropy encoding on the symbol data.

The encoder 12 according to an embodiment may perform inter-layer prediction in which a second layer image is predicted by using prediction information of a first layer image. In order to encode a second layer original image from a second layer image sequence through an inter-layer prediction structure, the encoder 12 may determine motion information of a second layer current image by using motion information of a reconstructed first layer image, and may encode a prediction error between the second layer original image and a second layer prediction image by generating the second layer prediction image based on the determined motion information.

The encoder 12 may determine a block of a first layer image to be referenced by a block of a second layer image by performing inter-layer prediction on the second layer image according to coding units or prediction units. For example, a reconstruction block of the first layer image, which is located correspondingly to a location of a current block in the second layer image, may be determined. The encoder 12 may use the reconstructed first layer block corresponding to a second layer block, as a second layer prediction block. Here, the encoder 12 may determine the second layer prediction block by using the reconstructed first layer block that is co-located with the second layer block.

The encoder 12 may use the second layer prediction block determined by using the reconstructed first layer block according to the inter-layer prediction structure, as a reference image for inter-layer prediction with respect to a second layer original block. The encoder 12 may perform transformation and quantization on an error between a sample value of the second layer prediction block and a sample value of the second layer original block, i.e., a residual component according to inter-layer prediction, by using the reconstructed first layer block, and may perform entropy encoding on quantized transformation coefficients.

The encoder 12 may determine a disparity vector of a current block.

The disparity vector of the current block may be determined according to a neighboring block candidate or a depth value. The disparity vector may include a neighboring block disparity vector (NBDV) and a depth oriented NBDV (DoNBDV). In this regard, the NBDV may refer to a disparity vector of the current block which is predicted by using a disparity vector obtained from among neighboring block candidates of the current block.

Also, when a decoded depth image exists in a different-layer image, a depth block corresponding to the current block may be determined by using the NBDV. In this regard, a camera parameter (e.g., a scaling value or an offset value in consideration of a location of a camera) is applied to a representative depth value from among depth values included in the determined depth block, so that the representative depth value may be converted to a disparity vector. In this case, the DoNBDV may refer to a disparity vector of the current block which is predicted by using the converted disparity vector.

The encoder 12 may determine the disparity vector of the current block to be equal to the NBDV that is the disparity vector of the neighboring block candidate of the current block.

Alternatively, the encoder 12 may derive the disparity vector of the current block by using the disparity vector of the neighboring block candidate. For example, the encoder 12 may apply a camera parameter to the NBDV that is the disparity vector of the neighboring block candidate and thus may derive the DoNBDV that is the disparity vector of the current block.

When the encoder 12 determines the disparity vector of the current block, the encoder 12 may determine a depth block corresponding to the current block by using the determined disparity vector, and may perform a depth-based block partition (DBBP) function to partition the current block, based on the determined depth block. According to the DBBP, the current block may be partitioned into a background segment and a foreground segment, based on the depth block corresponding to the current block, and prediction may be performed on each segment.

The encoder 12 may obtain a size of the current block, and when the size of the current block is greater than a predetermined size, the encoder 12 may apply the DBBP function. That is, when the size of the current block is equal to or less than the predetermined size, the encoder 12 may skip performing the DBBP function. For example, when the size of the current block is greater than 8×8, the encoder 12 may perform the DBBP function.

Alternatively, when the size of the current block is greater than one of 4×4, 16×16, 32×32, and 64×64, the encoder 12 may perform the DBBP function.

In order to perform the DBBP function, the encoder 12 may determine a depth block, which is indicated by the disparity vector of the current block, to be a depth block corresponding to the current block.

The encoder 12 may split the determined depth block into a plurality of regions. For example, the encoder 12 may split the depth block into a first region and a second region, wherein the first region is a region of samples having sample values each being greater than a threshold value, and the second region is a region of samples having sample values each being equal to or less than the threshold value.

The encoder 12 may split the current block into a plurality of regions based on split shapes of the depth block corresponding to the current block. For example, if the depth block corresponding to the current block is split into the first region and the second region, the encoder 12 may split the current block into two regions by matching the first and second regions and the current block.

The encoder 12 may perform motion prediction (or disparity prediction) on the current block by using the plurality of split regions.

For example, the encoder 12 may determine a motion vector (or a disparity vector) for each of the split two regions of the current block. The encoder 12 may determine motion vectors (or disparity vectors) respectively indicating reference blocks of the two regions, and may perform motion compensation (or disparity compensation) on each of the two regions of the current block by using the reference blocks.

Also, when the disparity vector of the current block is determined, the encoder 12 may perform residual prediction on the current block by using the determined disparity vector.

The residual prediction is a technique of predicting a residual component of a current block from a residual component of a reference block that corresponds to the current block and is present in an image input at a view or a time different from that of the current block.

For example, when the encoder 12 performs temporal-direction prediction, the encoder 12 may perform the residual prediction on the current block by using a residual component of a block indicated by a reference block corresponding to a view different from that of the current block. Alternatively, when the encoder 12 performs inter-view prediction, the encoder 12 may predict a residual component of the current block by using a residual component of a block indicated by a reference block corresponding to a view equal to that of the current block.

In this regard, the encoder 12 may perform the residual prediction when a size of the current block is greater than a predetermined size of the block. That is, when the size of the current block is equal to or less than the predetermined size, the encoder 12 may skip performing the residual prediction. For example, the encoder 12 may perform the residual prediction when the size of the current block is greater than 8×8.

Alternatively, the encoder 12 may perform the residual prediction when the size of the current block is greater than one of 4×4, 16×16, 32×32, and 64×64.

The bitstream generator 14 may generate a bitstream including a plurality of items of data generated as a result of performing at least one of the motion prediction and the residual prediction.

Hereinafter, operations of the multilayer video encoding apparatus 10 will now be described in detail with reference to FIGS. 1A through 1D.

FIG. 1B is a flowchart of a multilayer video encoding method, according to an embodiment.

In operation S11, the multilayer video encoding apparatus 10 may determine a neighboring block candidate that may be referenced from among neighboring blocks of a current block. One neighboring block candidate to be used in prediction may be determined from among one or more neighboring block candidates.

In operation S12, the multilayer video encoding apparatus 10 may obtain a disparity vector of the determined neighboring block.

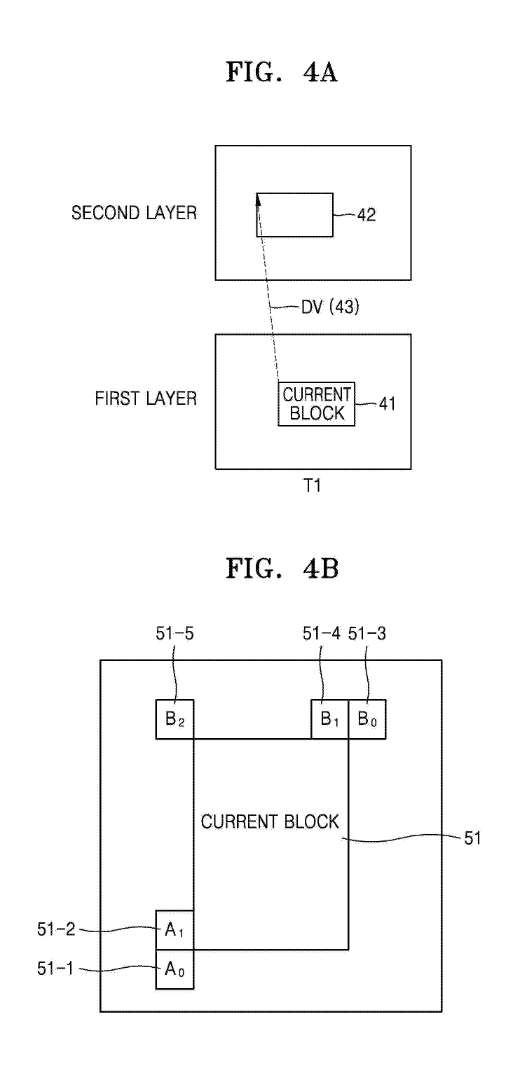

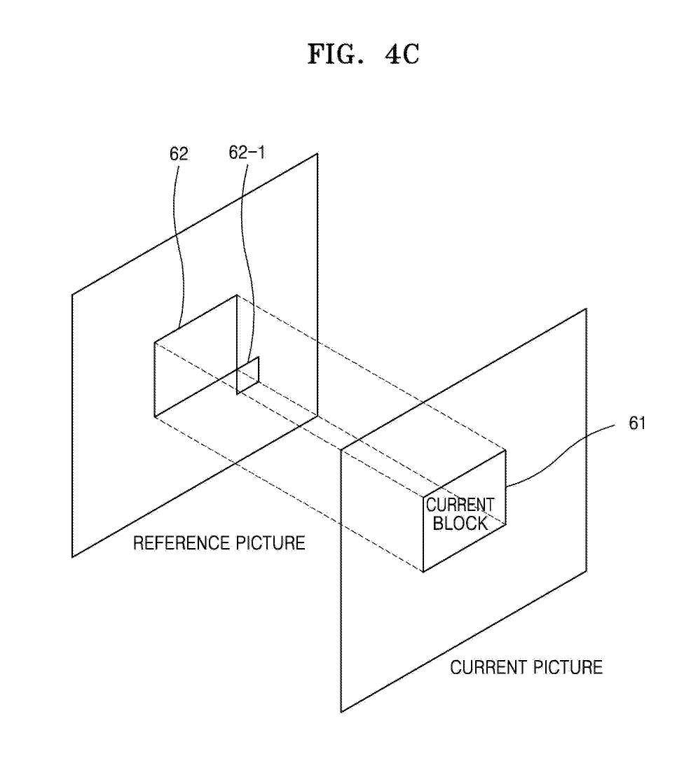

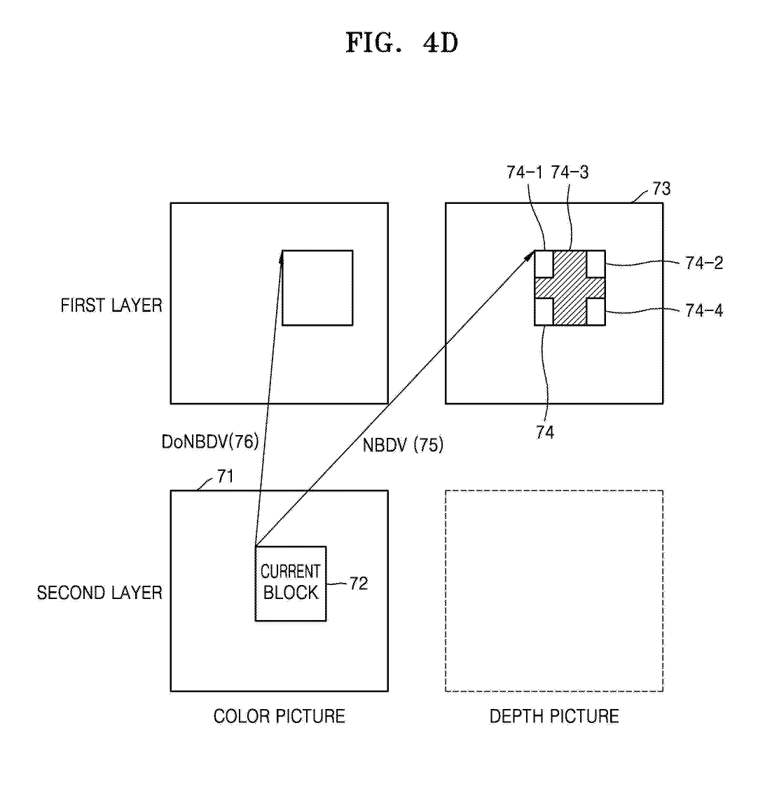

The multilayer video encoding apparatus 10 may use a spatial neighboring block candidate or a temporal neighboring block candidate of the current block as the neighboring block candidate of the current block. The disparity vector may be obtained from the neighboring block candidate to be used in prediction, the neighboring block candidate being from among the neighboring block candidates. A method of obtaining the disparity vector, the method being performed by the multilayer video encoding apparatus 10, will be described in detail below with respect to the multilayer video decoding apparatus 20 in FIGS. 4A through 4D.

In operation S13, the multilayer video encoding apparatus 10 may determine the obtained disparity vector of the neighboring block candidate to be a disparity vector of the current block. That is, the multilayer video encoding apparatus 10 may determine the disparity vector of the current block to be equal to a NBDV that is the disparity vector of the neighboring block candidate.

In operation S14, the multilayer video encoding apparatus 10 may determine a depth block corresponding to the current block by using the determined disparity vector. For example, the multilayer video encoding apparatus 10 may determine, as the depth block corresponding to the current block, a reference block of a depth picture which is indicated by the disparity vector.

In operation S14, the current block may be split into a plurality of regions, according to a region-split shape of the determined depth block. FIG. 1C is a flowchart of a multilayer video encoding method, according to another embodiment.

In operation S21, the multilayer video encoding apparatus 10 may obtain a disparity vector of a current block.

In operation S22, when a size of the current block is greater than a predetermined size, the multilayer video encoding apparatus 10 may split the current block into a plurality of regions, based on a depth block indicated by the disparity vector. For example, when the size of the current block is greater than the predetermined size, the multilayer video encoding apparatus 10 may apply a DBBP function. That is, when the size of the current block is equal to or less than the predetermined size, the multilayer video encoding apparatus 10 may skip performing the DBBP function. In this regard, the predetermined size of a block may be 8×8.

Alternatively, the predetermined size of the block may be one of the 4×4, 16×16, 32×32, and 64×6.

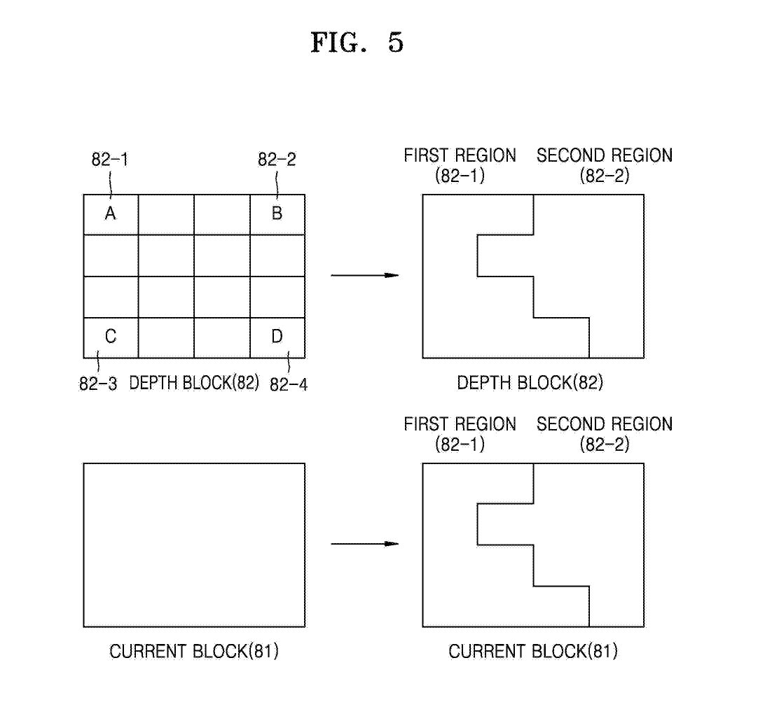

A method of splitting the current block into the plurality of regions based on the depth block indicated by the disparity vector, the method being performed by the multilayer video encoding apparatus 10, will be described in detail below with respect to the multilayer video decoding apparatus 20 in FIGS. 5 through 7B.

FIG. 1D is a flowchart of a multilayer video encoding method, according to another embodiment.

In operation S31, the multilayer video encoding apparatus 10 may obtain a disparity vector of a current block.

In operation S32, the multilayer video encoding apparatus 10 may obtain a residual component of a reference block indicated by the disparity vector of the current block. In operation S33, when a size of the current block is greater than a predetermined size, the multilayer video encoding apparatus 10 may predict a residual component of the current block by using the residual component of the reference block. That is, when the size of the current block is equal to or less than the predetermined size, the multilayer video encoding apparatus 10 may skip performing residual prediction. For example, the multilayer video encoding apparatus 10 may perform the residual prediction when the size of the current block is greater than 8×8.

Alternatively, the multilayer video encoding apparatus 10 may perform the residual prediction when the size of the current block is greater than one of 4×4, 16×16, 32×32, and 64×64.

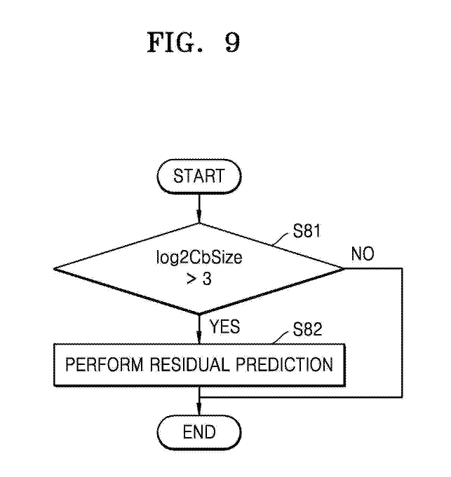

A method of predicting the residual component of the current block by using the residual component of the reference block, the method being performed by the multilayer video encoding apparatus 10, will be described in detail below with respect to the multilayer video decoding apparatus 20 in FIGS. 8A through 9.

The multilayer video encoding apparatus 10 may predict the residual component of the current block by using the residual component of the reference block and may encode a difference between the residual component of the current block and the residual component of the reference block.

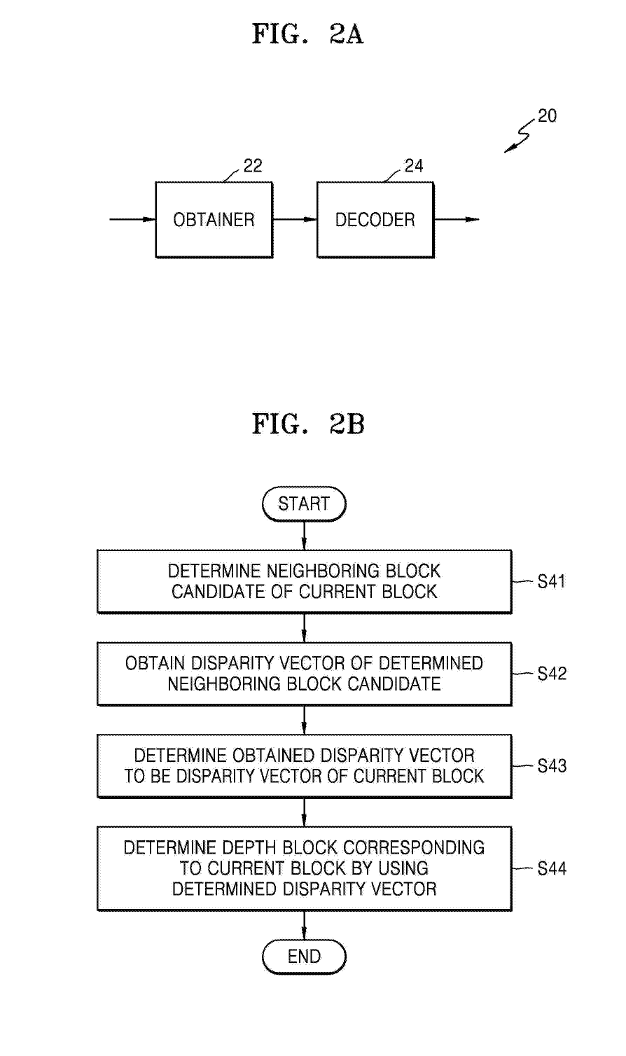

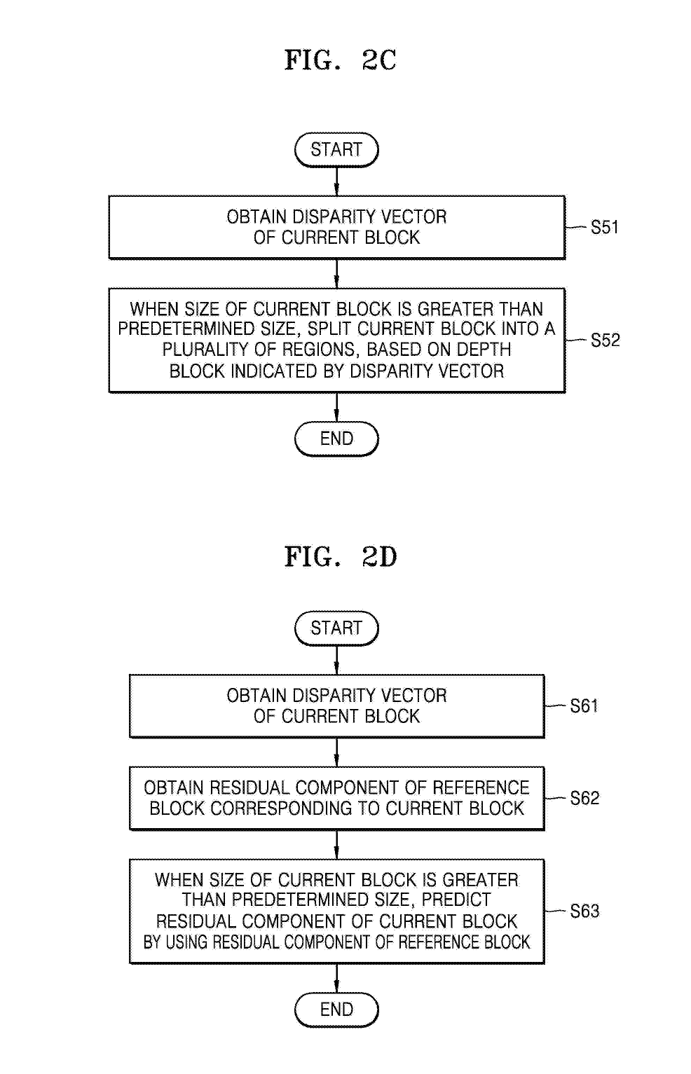

FIG. 2A is a block diagram of a multilayer video decoding apparatus, according to an embodiment.

Referring to FIG. 2A, a multilayer video decoding apparatus 20 may include an obtainer 22 and a decoder 24.

The multilayer video decoding apparatus 20 according to an embodiment may parse, from a bitstream, symbols according to layers.

The multilayer video decoding apparatus 20 based on spatial scalability may receive a stream in which image sequences having different resolutions are encoded in different layers. A first layer stream may be decoded to reconstruct an image sequence having a low resolution and a second layer stream may be decoded to reconstruct an image sequence having a high resolution.

As another example, a multiview video may be decoded according to a scalable video coding scheme. When a stereoscopic video stream is decoded to a plurality of layers, a first layer stream may be decoded to reconstruct left-view images. A second layer stream in addition to the first layer stream may be further decoded to reconstruct right-view images.

Alternatively, when a multiview video stream is decoded to a plurality of layers, a first layer stream may be decoded to reconstruct central-view images. A second layer stream in addition to the first layer stream may be further decoded to reconstruct left-view images. A third layer stream in addition to the first layer stream may be further decoded to reconstruct right-view images.

As another example, a scalable video coding method based on temporal scalability may be performed. A first layer stream may be decoded to reconstruct base frame rate images. A second layer stream may be further decoded to reconstruct high frame rate images.

Also, when there are at least three second layers, first layer images may be reconstructed from a first layer stream, and when a second layer stream is further decoded by referring to the reconstructed first layer images, second layer images may be further reconstructed. When a K-th layer stream is further decoded by referring to the reconstructed second layer images, K-th layer images may be further reconstructed.

The multilayer video decoding apparatus 20 may obtain encoded data of the first layer images and the second layer images from the first layer stream and the second layer stream, and in addition, may further obtain a motion vector generated through inter prediction and prediction information generated through inter-layer prediction.

For example, the multilayer video decoding apparatus 20 may decode inter-predicted data per layer, and may decode inter-layer predicted data between a plurality of layers. Reconstruction may be performed through motion compensation and inter-layer video decoding based on a coding unit or a prediction unit.

Images may be reconstructed by performing motion compensation for a current image by referencing reconstructed images predicted through inter prediction of a same layer, with respect to each layer stream. The motion compensation is an operation in which reconstructed images of the current image are reconfigured by synthesizing a reference image determined by using a motion vector of the current image and a residual component of the current image.

Also, the multilayer video decoding apparatus 20 may perform inter-layer video decoding by referring to prediction information of the first layer images so as to decode a second layer image predicted through inter-layer prediction. The inter-layer video decoding is an operation in which motion information of the current image is reconstructed by using prediction information of a reference block of a different layer so as to determine the motion information of the current image.

The multilayer video decoding apparatus 20 according to an embodiment may perform inter-layer video decoding for reconstructing third layer images predicted by using the second layer images. An inter-layer prediction structure will be described below with reference to FIG. 3A.

However, the decoder 24 according to an embodiment may decode THE second layer stream without referring to the first layer image sequence. Accordingly, it should not be limitedly construed that the decoder 24 performs the inter-layer prediction to decode the second layer image sequence.

The multilayer video decoding apparatus 20 performs decoding according to blocks of each image of a video. A block may be, from among coding units according to a tree structure, a largest coding unit, a coding unit, a prediction unit, or a transformation unit.

The obtainer 22 may receive the bitstream, and may obtain information regarding an encoded image from the received bitstream.

The decoder 24 may decode the first layer image by using parsed encoding symbols of the first layer image. When the multilayer video decoding apparatus 20 receives streams encoded based on coding units of a tree structure, the decoder 24 may perform decoding based on the coding units of the tree structure, according to a largest coding unit of the first layer stream.

The decoder 24 may obtain encoding information and encoded data by performing entropy decoding per largest coding unit. The decoder 24 may reconstruct a residual component by performing inverse quantization and inverse transformation on the encoded data obtained from a stream. The decoder 24 according to another embodiment may directly receive a bitstream of quantized transformation coefficients. The residual component of images may be reconstructed by performing inverse quantization and inverse transformation on the quantized transformation coefficients.

The decoder 24 may determine a prediction image through motion compensation between same layer images, and may reconstruct the first layer images by combining the prediction image and the residual component.

According to the inter-layer prediction structure, the decoder 24 may generate a second layer prediction image by using samples of a reconstructed first layer image. The decoder 24 may obtain a prediction error according to inter-layer prediction by decoding a second layer stream. The decoder 24 may generate a reconstructed second layer image by combining the second layer prediction image and the prediction error.

The decoder 24 may determine the second layer prediction image by using the reconstructed first layer image decoded by the decoder 24. According to the inter-layer prediction structure, the decoder 24 may determine a block of a first layer image which is to be referenced by a coding unit or a prediction unit of a second layer image. For example, a reconstructed block of the first layer image which is co-located with a current block of the second layer image. The decoder 24 may determine a second layer prediction block by using the reconstructed first layer block corresponding to a second layer block. The decoder 24 may determine the second layer prediction block by using the reconstructed first layer block that is co-located with the second layer block.

The decoder 24 may use the second layer prediction block determined by using the reconstructed first layer block according to the inter-layer prediction structure, as a reference image for inter-layer prediction of a second layer original block. In this case, the decoder 24 may reconstruct the second layer block by synthesizing a sample value of the second layer prediction block determined by using the reconstructed first layer image and the residual component according to the inter-layer prediction.

The aforementioned decoder 24 may determine a disparity vector of the current block.

The decoder 24 may determine the disparity vector of the current block by using an NBDV that is a disparity vector of a neighboring block candidate of the current block.

Alternatively, the decoder 24 may derive the disparity vector of the current block by using the disparity vector of the neighboring block candidate. For example, the decoder 24 may apply a camera parameter to the NBDV that is the disparity vector of the neighboring block candidate and thus may derive an DoNBDV that is the disparity vector of the current block.

When the disparity vector of the current block is determined, the decoder 24 may perform a DBBP function to split the current block by using the determined disparity vector.

In this regard, when a size of the current block is greater than a predetermined size, the decoder 24 may apply the DBBP function. That is, when the size of the current block is equal to or less than the predetermined size, the decoder 24 may skip performing the DBBP function. For example, when the size of the current block is greater than 8×8, the decoder 24 may perform the DBBP function.

Alternatively, when the size of the current block is greater than one of 4×4, 16×16, 32×32, and 64×64, the decoder 24 may perform the DBBP function.

According to the DBBP function, the decoder 24 may determine a depth block, which is indicated by the disparity vector of the current block, to be a depth block corresponding to the current block.

The decoder 24 may split the determined depth block into a plurality of regions, and may split the current block into a plurality of regions, based on split shapes of the depth block.

The decoder 24 may perform motion prediction on the current block by using the plurality of split regions. For example, the decoder 24 may determine a motion vector (or a disparity vector) for each of the split two regions of the current block. The decoder 24 may determine reference blocks of the two regions by using the determined motion vector, and may perform motion compensation (or disparity compensation) on each of the two regions of the current block by using the determined reference blocks.

Also, when the disparity vector of the current block is determined, the decoder 24 may perform residual prediction on the current block by using the determined disparity vector.

According to the residual prediction, a residual component of the current block may be predicted from a residual component of a reference block that corresponds to the current block and is present in an image input at a view or a time different from that of the current block.

For example, when the decoder 24 performs temporal-direction prediction, the decoder 24 may perform the residual prediction on the current block by using a residual component of a block indicated by a reference block corresponding to a view equal to that of the current block. Alternatively, when the decoder 24 performs inter-view prediction, the decoder 24 may perform the residual prediction on the current block by using a residual component of a block indicated by a reference block corresponding to a view different from that of the current block.

In this regard, the decoder 24 may perform the residual prediction when the size of the current block is greater than the predetermined size. That is, when the size of the current block is equal to or less than the predetermined size, the decoder 24 may skip performing the residual prediction. For example, the decoder 24 may perform the residual prediction when the size of the current block is greater than 8×8.

Alternatively, the decoder 24 may perform the residual prediction when the size of the current block is greater than one of 4×4, 16×16, 32×32, and 64×64.

The decoder 24 may decode the current block by performing at least one of the motion prediction and the residual prediction.

Hereinafter, operations of the multilayer video decoding apparatus 20 will now be described in detail below with reference to FIGS. 2B through 2D.

FIG. 2B is a flowchart of a multilayer video decoding method, according to an embodiment.

In operation S41, the multilayer video decoding apparatus 20 may determine a neighboring block candidate that may be referenced from among neighboring blocks of a current block. One neighboring block candidate to be used in prediction may be determined from among one or more neighboring block candidates.

In operation S42, the multilayer video decoding apparatus 20 may obtain a disparity vector of the determined neighboring block.

The multilayer video decoding apparatus 20 may use a spatial neighboring block candidate or a temporal neighboring block candidate of the current block as the neighboring block candidate of the current block. The disparity vector may be obtained from the neighboring block candidate to be used in prediction, the neighboring block candidate being from among the neighboring block candidates. A method of obtaining the disparity vector, the method being performed by the multilayer video decoding apparatus 20, will be described in detail below with reference to FIGS. 4A through 4D.

In operation S43, the multilayer video decoding apparatus 20 may determine the obtained disparity vector of the neighboring block candidate to be a disparity vector of the current block. That is, the multilayer video decoding apparatus 20 may determine the disparity vector of the current block to be equal to a NBDV that is the disparity vector of the neighboring block candidate.

In operation S44, the multilayer video decoding apparatus 20 may determine a depth block corresponding to the current block, by using the determined disparity vector. For example, the multilayer video decoding apparatus 20 may determine, as the depth block corresponding to the current block, a reference block of a depth picture which is indicated by the disparity vector.

FIG. 2C is a flowchart of a multilayer video decoding method, according to another embodiment.

In operation S51, the multilayer video decoding apparatus 20 may obtain a disparity vector of a current block.

In operation S52, when a size of the current block is greater than a predetermined size, the multilayer video decoding apparatus 20 may split the current block into a plurality of regions, based on a depth block indicated by the disparity vector. For example, when the size of the current block is greater than the predetermined size, the multilayer video decoding apparatus 20 may apply a DBBP function. That is, when the size of the current block is equal to or less than the predetermined size, the multilayer video decoding apparatus 20 may skip performing the DBBP function. In this regard, the predetermined size of a block may be 8×8.

Alternatively, the predetermined size of the block may be one of the 4×4, 16×16, 32×32, and 64×6.

A method of splitting the current block into the plurality of regions based on the depth block indicated by the disparity vector, the method being performed by the multilayer video decoding apparatus 20, will be described in detail below with reference to FIGS. 5 through 7B.

FIG. 2D is a flowchart of a multilayer video decoding method, according to another embodiment.

In operation S61, the multilayer video decoding apparatus 20 may obtain a disparity vector of a current block.

In operation S62, the multilayer video decoding apparatus 20 may obtain a residual component of a reference block corresponding to the current block. In operation S63, when a size of the current block is greater than a predetermined size, the multilayer video decoding apparatus 20 may predict a residual component of the current block by using the residual component of the reference block. That is, when the size of the current block is equal to or less than the predetermined size, the multilayer video decoding apparatus 20 may skip performing residual prediction. For example, the multilayer video decoding apparatus 20 may perform the residual prediction when the size of the current block is greater than 8×8.

Alternatively, the multilayer video decoding apparatus 20 may perform the residual prediction when the size of the current block is greater than one of 4×4, 16×16, 32×32, and 64×64.

A method of predicting the residual component of the current block by using the residual component of the reference block, the method being performed by the multilayer video decoding apparatus 20, will be described in detail below with reference to FIGS. 8A through 9.

FIG. 3A is a diagram of an inter-layer prediction structure, according to an embodiment.

The multilayer video encoding apparatus 10 according to an embodiment may prediction-encode base-view images, left-view images, and right-view images according to a reproduction order 50 of a multiview video prediction structure of FIG. 3A.

According to an embodiment, the base-view images, the left-view images, and the right-view images may respectively correspond to images of different layers. For example, a base view may correspond to a first layer, a left view may correspond to a second layer, and a right view may correspond to a third layer.

According to the reproduction order 50 of the multiview video prediction structure according to a related technology, images corresponding to a same view are arranged in a horizontal direction. Accordingly, the left-view images indicated by ‘Left’ are arranged in the horizontal direction in a row, the base-view images indicated by ‘Center’ are arranged in the horizontal direction in a row, and the right-view images indicated by ‘Right’ are arranged in the horizontal direction in a row. Compared to the left/right-view images, the base-view images may be central-view images.

Also, images having a same picture order count (POC) order are arranged in a vertical direction. A POC order of images indicates a reproduction order of images forming a video. ‘POC X’ indicated in the reproduction order 50 of the multiview video prediction structure indicates a relative reproduction order of images in a corresponding column, wherein a reproduction order is in front when a value of X is low, and is behind when the value of X is high.

Thus, according to the reproduction order 50 of the multiview video prediction structure according to the related technology, the left-view images indicated by ‘Left’ are arranged in the horizontal direction according to the POC order (reproduction order), the base-view images indicated by ‘Center’ are arranged in the horizontal direction according to the POC order (reproduction order), and the right-view images indicated by ‘Right’ are arranged in the horizontal direction according to the POC order (reproduction order). Also, the left-view image and the right-view image located on the same column as the base-view image have different views but the same POC order (reproduction order).

Four consecutive images form one group of pictures (GOP) according to views. Each GOP includes images between consecutive anchor pictures, and one anchor picture (key picture).

An anchor picture is a random access point, and when a reproduction location is arbitrarily selected from images arranged according to a reproduction order, i.e., a POC order, while reproducing a video, an anchor picture closest to the reproduction location according to the POC order is reproduced. The base-layer images include base-layer anchor pictures 51, 52, 53, 54, and 55, the left-view images include left-view anchor pictures 131, 132, 133, 134, and 135, and the right-view images include right-view anchor pictures 231, 232, 233, 234, and 235.

Multiview images may be reproduced and predicted (reconstructed) according to a GOP order. First, according to the reproduction order 50 of the multiview video prediction structure, images included in GOP 0 may be reproduced, and then images included in GOP 1 may be reproduced, according to views. That is, images included in each GOP may be reproduced in an order of GOP 0, GOP 1, GOP 2, and GOP 3. Also, according to a coding order of the multiview video prediction structure, the images included in GOP 0 may be predicted, and then the images included in GOP 1 may be predicted, according to views. That is, the images included in each GOP may be predicted in an order of GOP 0, GOP 1, GOP 2, and GOP 3.

According to the reproduction order 50 of the multiview video prediction structure, inter-view prediction (inter-layer prediction) and inter prediction are all performed on images. In the multiview video prediction structure, an image where an arrow starts is a reference image, and an image where an arrow ends is an image predicted by using a reference image.

A prediction result of base-view images may be encoded and then output in a form of a base-view image stream, and a prediction result of additional view images may be encoded and then output in a form of a layer bitstream. Also, a prediction encoding result of left-view images may be output as a first layer bitstream, and a prediction encoding result of right-view images may be output as a second layer bitstream.

Only inter-prediction is performed on base-view images. That is, the base-layer anchor pictures 51, 52, 53, 54, and 55 of an I-picture type do not refer to other images, but remaining images of a B-picture type and a b-picture type are predicted by referring to other base-view images. Images of a B-picture type are predicted by referring to an anchor picture of an I-picture type, which precedes the images of a B-picture type according to a POC order, and a following anchor picture of an I-picture type. Images of a b-picture type are predicted by referring to an anchor picture of an I-type, which precedes the image of a b-picture type according a POC order, and a following image of a B-picture type, or by referring to an image of a B-picture type, which precedes the images of a b-picture type according to a POC order, and a following anchor picture of an I-picture type.

Inter-view prediction (inter-layer prediction) that references different view images, and inter prediction that references same view images are performed on each of left-view images and right-view images.

Inter-view prediction (inter-layer prediction) may be performed on the left-view anchor pictures 131, 132, 133, 134, and 135 by respectively referring to the base-view anchor pictures 51, 52, 53, 54, and 55 having the same POC order. Inter-view prediction may be performed on the right-view anchor pictures 231, 232, 233, 234, and 235 by respectively referring to the base-view anchor pictures 51, 52, 53, 54, and 55 or the left-view anchor pictures 131, 132, 133, 134, and 135 having the same POC order. Also, inter-view prediction (inter-layer prediction) may be performed on remaining images other than the left-view images 131, 132, 133, 134, and 135 and the right-view images 231, 232, 233, 234, and 235 by referring to other view images having the same POC.

Remaining images other than the anchor pictures 131, 132, 133, 134, 135, 231, 232, 233, 234, and 235 from among left-view images and right-view images are predicted by referring to the same view images.

However, each of the left-view images and the right-view images may not be predicted by referring to an anchor picture that has a preceding reproduction order from among additional view images of the same view. That is, in order to perform inter prediction on a current left-view image, left-view images excluding a left-view anchor picture that precedes the current left-view image in a reproduction order may be referenced. Equally, in order to perform inter prediction on a current right-view image, right-view images excluding a right-view anchor picture that precedes the current right-view image in a reproduction order may be referenced.

Also, in order to perform inter prediction on a current left-view image, prediction may be performed by referring to a left-view image that belongs to a current GOP but is to be reconstructed before the current left-view image, instead of referring to a left-view image that belongs to a GOP before the current GOP of the current left-view image. The same is applied to a right-view image.

The multilayer video decoding apparatus 20 according to an embodiment may reconstruct base-view images, left-view images, and right-view images according to the reproduction order 50 of the multiview video prediction structure of FIG. 3A.

Left-view images may be reconstructed via inter-view disparity compensation that references base-view images and inter motion compensation that references left-view images. Right-view images may be reconstructed via inter-view disparity compensation that references base-view images and left-view images, and inter motion compensation that references right-view images. Reference images may be reconstructed first for disparity compensation and motion compensation of left-view images and right-view images.

For inter motion compensation of a left-view image, left-view images may be reconstructed through inter motion compensation that references a reconstructed left-view reference image. For inter motion compensation of a right-view image, right-view images may be reconstructed through inter motion compensation that references a reconstructed right-view reference image.

Also, for inter motion compensation of a current left-view image, only a left-view image that belongs to a current GOP of the current left-view image but is to be reconstructed before the current left-view image may be referenced, and a left-view image that belongs to a GOP before the current GOP is not referenced. The same is applied to a right-view image.

Also, the multilayer video decoding apparatus 20 according to an embodiment may not only perform disparity compensation (or inter-layer prediction compensation) to encode or decode a multiview image, but may also perform motion compensation between images (or inter-layer motion prediction) through inter-view motion vector prediction.

FIG. 3B illustrates a multilayer video according to an embodiment.

In order to provide an optimum service in various network environments and various terminals, the multilayer video encoding apparatus 10 may output a scalable bitstream by encoding multilayer image sequences having various spatial resolutions, various qualities, various frame rates, and different views. That is, the multilayer video encoding apparatus 10 may generate and output a scalable video bitstream by encoding an input image according to various scalability types. Scalability includes temporal, spatial, quality, and multiview scalabilities, and a combination thereof. Such scalabilities may be classified according to types. Also, the scalabilities may be classified as a dimension identifier in each type.

For example, the scalability has the same scalability type as the temporal, spatial, quality, and multiview scalability. Also, the scalability may be classified into a scalability dimension identifier according to types. For example, when scalabilities are different, the scalabilities may have different dimension identifiers. For example, a high scalability dimension may be assigned to a high-dimensional scalability with respect to the scalability type.

When a bitstream is dividable into valid substreams, the bitstream is scalable. A spatially-scalable bitstream includes substreams of various resolutions. In order to distinguish different scalabilities in the same scalability type, a scalability dimension is used. The scalability dimension may be expressed by a scalability dimension identifier.

For example, the spatially-scalable bitstream may be divided into substreams having different resolutions, such as a quarter video graphics array (QVGA), a video graphics array (VGA), a wide video graphics array (WVGA), or the like. For example, layers having different resolutions may be distinguished by using a dimension identifier. For example, the QVGA substream may have 0 as a spatial scalability dimension identifier value, the VGA substream may have 1 as a spatial scalability dimension identifier value, and the WVGA substream may have 2 as a spatial scalability dimension identifier value.

A temporally-scalable bitstream includes substreams having various frame rates. For example, the temporally-scalable bitstream may be divided into substreams having a frame rate of 7.5 Hz, a frame rate of 15 Hz, a frame rate of 30 Hz, and a frame rate of 60 Hz. A quality scalable bitstream may be divided into substreams having different qualities according to a coarse-grained scalability (CGS) method, a medium-grained scalability (MGS) method, and a fine-grained scalability (FGS) method. The temporal scalability may also be distinguished according to different dimensions according to different frame rates, and the quality scalability may also be distinguished according to different dimensions according to different methods.

A multiview scalable bitstream includes substreams of different views in one bitstream. For example, in a stereoscopic image, a bitstream includes a left image and a right image. Also, a scalable bitstream may include substreams related to a multiview image and encoded data of a depth map. The viewpoint scalability may also be distinguished according to different dimensions according to different views.

Different scalable expansion types may be combined with each other. That is, a scalable video bitstream may include substreams in which image sequences of a multilayer including images, wherein at least one of temporal, spatial, quality, and multiview scalabilities are different from each other, are encoded.

FIG. 3B illustrates image sequences 3010, 3020, and 3030 having different scalable expansion types. The image sequence 3010 of a first layer, the image sequence 3020 of a second layer, and the image sequence 3030 of an n-th layer (n is an integer) may be image sequences in which at least one of a resolution, a quality, and a view are different from each other. Also, one of the image sequence 3010 of the first layer, the image sequence 3020 of the second layer, and the image sequence 3030 of the n-th layer may be an image sequence of a base layer and the other image sequences may be image sequences of an enhancement layer.

For example, the image sequence 3010 of the first layer may include first-view images, the image sequence 3020 of the second layer may include second-view images, and the image sequence 3030 of the n-th layer may include n-th view images. As another example, the image sequence 3010 of the first layer may be a left-view image of a base layer, the image sequence 3020 of the second layer may be a right-view image of the base layer, and the image sequence 3030 of the n-th layer may be a right-view image of an enhancement layer. However, the preset disclosure is not limited to the aforementioned embodiment, and the image sequences 3010, 3020, and 3030 having different scalable expansion types may be image sequences having different image attributes.

FIG. 4A is a diagram for describing a disparity vector of a current block, according to an embodiment.

Referring to FIG. 4A, the multilayer video decoding apparatus 20 may determine a reference block 42 corresponding to a different view and a current block 41 by using a disparity vector 43. The multilayer video decoding apparatus 20 may predict the current block 41 by using the determined reference block 42.

The disparity vector may be transmitted, as separate information, from the multilayer video encoding apparatus 10 to the multilayer video decoding apparatus 20 via a bitstream, and may be determined based on a neighboring block candidate or a depth value. As described above, the disparity vector may include an NBDV and a DoNBDV.

FIG. 4B illustrates an example in which a disparity vector is obtained by using a spatially-neighboring block candidate of a current block, according to an embodiment.

Referring to FIG. 4B, the multilayer video decoding apparatus 20 may search spatially-neighboring block candidates according to a predetermined search order so as to obtain a disparity vector of a current block 51. In this regard, the searched neighboring block candidates may be prediction units that are temporally or spatially adjacent to the current block 51.

Candidates of the spatially-neighboring block candidates for obtaining the disparity vector may include a neighboring block candidate A0 51-1 located at the left bottom of the current block 51, a neighboring block candidate A1 51-2 located at the left of the current block 51, a neighboring block candidate B0 51-3 located at right top of the current block 51, a neighboring block candidate B1 51-4 located at the top of the current block 51, and a neighboring block candidate B 51-5 located at the left top of the current block 51. The neighboring block candidates may be searched in an order of neighboring block candidates A1 51-2, B1 51-4, B0 51-3, A0 51-1, and B2 51-5.

One neighboring block candidate to be used in prediction may be determined from among the neighboring block candidates, and the disparity vector of the current block 51 may be determined by using a disparity vector of the determined neighboring block candidate.

For example, the multilayer video decoding apparatus 20 may determine a disparity vector to be a base disparity vector DispVec of the current block 51, wherein the disparity vector is obtained from a spatially-neighboring block candidate from among the neighboring block candidates. If it is not available to obtain the disparity vector from the spatially-neighboring block candidate, the multilayer video decoding apparatus 20 may set a base disparity vector of a current block as a (0,0) vector.

Locations and the number of the neighboring block candidates for predicting the disparity vector are not limited to the embodiment and may be changed.

FIG. 4C illustrates an example in which a disparity vector is obtained by using a temporally-neighboring block candidate of a current block, according to an embodiment.

Referring to FIG. 4C, the multilayer video decoding apparatus 20 may determine at least one of a block 62 that is co-located with a current block 61 and another block adjacent to the co-located block 62, wherein the at least one is to be a temporally-neighboring block candidate. In this regard, the co-located block 62 may be a co-located block of a co-located picture. As another example, the co-located block 62 may be a co-located block of a random access picture. For example, a block 62-1 located at the right bottom of the co-located block 62 may be determined to be the temporally-neighboring block candidate. When a disparity vector is obtained from the temporally-neighboring block candidate from among neighboring block candidates, the multilayer video decoding apparatus 20 may determine a base disparity vector MvDisp of the current block 61 to be equal to the obtained disparity vector.

An example in which a disparity vector is obtained by using a spatially-neighboring block candidate and a temporally-neighboring block candidate of a current block is as below. As another example, spatially-neighboring block candidates for obtaining the disparity vector may include the neighboring block candidate A1 51-2 located at the left of the current block 51 and the neighboring block candidate B1 51-4 located at the top of the current block 51, and temporally-neighboring block candidates may include a co-located block of a co-located picture and a co-located block of a random access picture.

The neighboring block candidates may be searched in an order of the co-located block of the co-located picture, the co-located block of the random access picture, the neighboring block candidate A1 51-2, and the neighboring block candidate B1 51-4.

In FIGS. 4B and 4C, a neighboring block candidate for which disparity vector is determined from among the neighboring block candidates may be a reference block to predict a disparity vector of the current block. FIG. 4D illustrates an example in which a disparity vector of a current block is obtained by using a depth picture, according to an embodiment.

The multilayer video decoding apparatus 20 may determine whether a first layer depth picture 73 is available, by using depth refinement information depth_refinement_flag obtained from a bitstream. When the depth refinement information depth_refinement_flag indicates that the first layer depth picture 73 is available, the multilayer video decoding apparatus 20 may derive a disparity vector of a current block 72 by using a NBDV 75 obtained from the neighboring block candidate and the first layer depth picture 73.

In more detail, the multilayer video decoding apparatus 20 may determine a reference block 74 of the first layer depth picture 73 indicated by the NBDV 75 obtained from the neighboring block candidate of the current block 72 of a second layer. Next, the multilayer video decoding apparatus 20 may apply a camera parameter to at least one of depth values of corners 74-1, 74-2, 74-3, and 74-4 of the determined reference block 74, and may convert the at least one to a DoNBDV 76. The multilayer video decoding apparatus 20 may determine the DoNBDV 76 to be the disparity vector of the current block 72.

The method described with reference to FIGS. 4A through 4D is described with respect to the multilayer video decoding apparatus 20 and may also be applied to the multilayer video encoding apparatus 10.

In order for the multilayer video decoding apparatus 20 to obtain a DoNBDV, the multilayer video decoding apparatus 20 may fetch, from a memory, a reference block of a depth picture indicated by an NBDV, and may additionally fetch, from the memory, a reference block of a depth picture indicated by the DoNBDV so as to perform prediction compensation on a current block. In particular, since the depth picture is generally located in an external memory, bandwidth complexity of the memory may be further increased.

Therefore, in another embodiment, the multilayer video decoding apparatus 20 may determine a disparity vector of the current block to be an NBDV that is a disparity vector of a neighboring block candidate of the current block. That is, the multilayer video decoding apparatus 20 may determine a depth block, which corresponds to the current block for decoding, to be a depth block indicated by the NBDV. Accordingly, the bandwidth complexity of the memory may be decreased, and usage efficiency with respect to the memory may be improved.

To do so, by using syntax MvDisp[xTb][yTb], a value of a variable mvDisp for determining the disparity vector of the current block may be determined to be equal to a value of an NBDV(MvDisp[xTb][yTb]). Alternatively, by using syntax DispVec[xCb][xCb], a value of a variable dispVec for determining the disparity vector of the current block may be determined to be equal to a value of an NBDV(DispVec[xCb][xCb]).

When the disparity vector of the current block is determined, a depth block corresponding to the current block may be determined by using the determined disparity vector, and a DBBP function may be performed to split the current block, based on the determined depth block.

FIG. 5 illustrates an example in which a current block is split by using a depth block corresponding to the current block, according to an embodiment.

The multilayer video decoding apparatus 20 may split a depth block 82 corresponding to a current block 81 into a plurality of regions so as to split the current block 81, and may split the current block 81 into a plurality of regions, based on the plurality of split regions of the depth block 82.

In order to split the depth block 82 into the plurality of regions, the multilayer video decoding apparatus 20 may determine a threshold value. The threshold value refers to a reference value with respect to the split when the depth block 82 is split into the plurality of regions. The multilayer video decoding apparatus 20 may determine the threshold value by using sample values of the depth block 82. For example, the multilayer video decoding apparatus 20 may determine the threshold value to be an average value of the sample values included in the depth block 82. In more detail, the multilayer video decoding apparatus 20 may determine the threshold value to be an average value of sample values of corner samples of the depth block 82, the corner samples including a top-left sample 82-1, a top-right sample 82-2, a bottom-left sample 82-3, and a bottom-right sample 82-4.

Next, the multilayer video decoding apparatus 20 may split the depth block 82 into a first region 82-1 and a second region 82-2, wherein the first region 82-1 is a region of samples of which sample values are greater than the threshold value, and the second region 82-2 is a region of samples of which sample values are equal to or less than the threshold value. The multilayer video decoding apparatus 20 may split the current block 81 into a plurality of regions, based on split shapes of the depth block 82. For example, when the depth block 82 is split into the first region 82-1 and the second region 82-2, the multilayer video decoding apparatus 20 may split the current block 81 into a plurality of regions by matching the first and second regions 82-1 and 82-2 and the current block 81. That is, the multilayer video decoding apparatus 20 may generate a split map by using the first region 82-1 and the second region 82-2, and may split the current block 81 into the first region 82-1 and the second region 82-2 by matching the generated split map and the current block 81.

When the multilayer video decoding apparatus 20 accesses a region of a reference image corresponding to a current block, the multilayer video decoding apparatus 20 fetches, from the reference image, a region greater than a size of the current block when the size of the current block is decreased, so that a bandwidth of a memory may be increased. Therefore, in order to decrease the bandwidth of the memory, if the size of the current block is equal to or less than a predetermined size, the aforementioned DBBP that refers to a texture image or a depth image may be skipped.

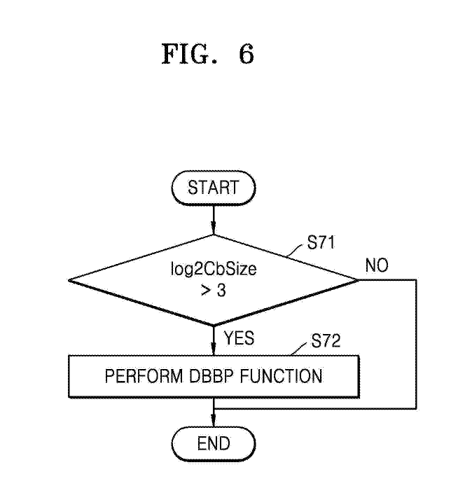

FIG. 6 is a flowchart of a method of determining whether to perform a DBBP function by taking into account a size of a current block, the method being performed by the multilayer video decoding apparatus 20, according to an embodiment.

In operation S71, the multilayer video decoding apparatus 20 may determine whether or not the size of the current block is greater than 8×8. That is, when the size of the current block is expressed as log 2CbSize by calculating log 2 of a size CbSize of the current block, the multilayer video decoding apparatus 20 may determine whether or not a log value of the size of the current block is greater than 3.

In operation S72, when the log value of the size of the current block is greater than 3 (S71-Y), the multilayer video decoding apparatus 20 may perform a DBBP function. On the other hand, when the log value of the size of the current block is equal to or less than 3 (S71-N), the multilayer video decoding apparatus 20 may not perform the DBBP function.

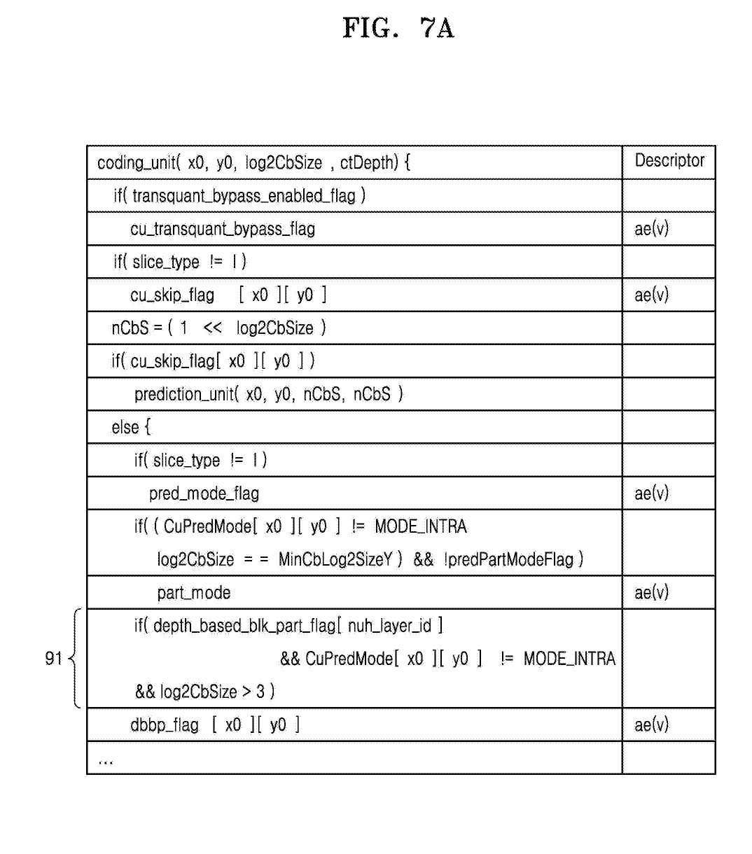

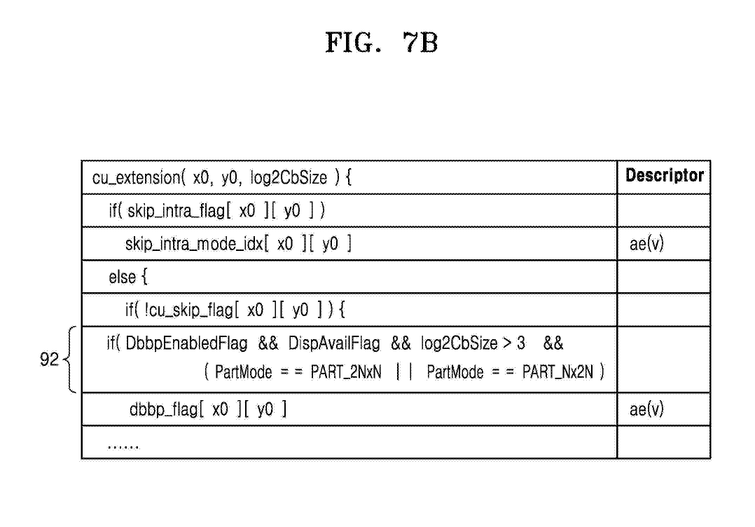

FIG. 7A illustrates an example of syntax for determining whether to perform DBBP by taking into account a size of a current block, the method being performed by the multilayer video decoding apparatus 20, according to an embodiment.

In FIG. 7A, syntax coding unit( ) for coding the current block may include a condition 91 for determining whether to perform the DBBP on the current block.

In the condition 91, when a value of a flag depth_based_blk_part_flag indicating whether to perform the DBBP on a layer including a current block (i.e., a coding unit (CU)) is not 0, a value of a prediction mode CuPredMode of the current block is not a value of an intra mode MODE_INTRA, and a value obtained by taking log 2 to a size CbSize of the current block is greater than 3, the multilayer video decoding apparatus 20 may obtain, from a bitstream, a flag dbbp_flag indicating whether to perform the DBBP on the current block. When a value of the flag dbbp_flag is 1, the multilayer video decoding apparatus 20 may perform the DBBP on the current block.

However, when the value of the flag dbbp_flag is 0, the multilayer video decoding apparatus 20 may not perform the DBBP.

When the size of the current block is greater than 8×8, the multilayer video decoding apparatus 20 may parse the flag dbbp_flag from the bitstream and may determine whether or not to perform the DBBP. However, when the size of the current block is equal to or less than 8×8, the multilayer video decoding apparatus 20 does not parse the flag dbbp_flag and does not perform the DBBP.

FIG. 7B illustrates an example of syntax for determining whether to perform DBBP by taking into account a size of a current block, the method being performed by the multilayer video decoding apparatus 20, according to another embodiment.

In FIG. 7B, syntax cu_extension( ) for coding the current block may include a condition 92 for determining whether to perform the DBBP on the current block.

In the condition 92, when a value of a flag DbbpEnabledFlag indicating whether to perform the DBBP on a layer including the current block is not 0, a value of a flag DispAvailFlag indicating whether an inter-view reference picture of the current block is present is not 0, a partition mode of the current block is PART_2 N×N or PART_N×2N, and a value obtained by taking log 2 to a size CbSize of the current block is greater than 3, the multilayer video decoding apparatus 20 may obtain, from a bitstream, a flag dbbp_flag indicating whether to perform the DBBP on the current block. That is, whether to perform the DBBP may be determined according to a value of the flag dbbp_flag.

However, when the partition mode of the current block is not PART_2 N×N nor PART_N×2N, the flag dbbp_flag is not obtained, and the DBBP cannot be performed.

Therefore, according to the embodiment of FIG. 7B, whether to perform the DBBP may be determined according to not only the size of the current block but also to the partition mode of the current block. When the size of the current block is greater than 8×8 and the partition mode of the current block is PART_2 N×N or PART_N×2N, the flag dbbp_flag with respect to performing the DBBP may be parsed.

The method described with reference to FIGS. 5 through 7B is described with respect to the multilayer video decoding apparatus 20 and may also be applied to the multilayer video encoding apparatus 10.

For example, when a DBBP function can be performed since a size of the current block is greater than a predetermined size, the multilayer video encoding apparatus 10 may set a flag “dbbp_flag” indicating whether to perform the DBBP function. A value of “dbbp_flag” may be set to 1 for a case where the DBBP function is performed, and the value of “dbbp_flag” may be set to 0 for a case where the DBBP function is not performed.

The multilayer video encoding apparatus 10 may encode information regarding whether to perform the DBBP function. For example, the multilayer video encoding apparatus 10 may encode “dbbp_flag” and may include it in a bitstream.

When the DBBP function is not performed since the size of the current block is equal to or less than the predetermined size, it is not required for the multilayer video encoding apparatus 10 to encode the flag “dbbp_flag” indicating whether to perform the DBBP function.

When a disparity vector of the current block is determined, the multilayer video decoding apparatus 20 may perform residual prediction on the current block by using the determined disparity vector.

FIG. 8A illustrates an example in which the multilayer video decoding apparatus 20 performs residual prediction, according to an embodiment.

In FIG. 8A, when the multilayer video decoding apparatus 20 performs temporal-direction prediction, the multilayer video decoding apparatus 20 may obtain a sample value of a reference block 104 included in a previous picture 103 of a second layer, the reference block 104 being indicated by a motion vector 107 of a current block 102 included in a current picture 101 of the second layer. Then, the multilayer video decoding apparatus 20 may obtain a residual component of a reference block 106 included in a current picture 105 of a first layer, the reference block 106 being indicated by a disparity vector 108 of the current block 102 of the second layer. Then, the multilayer video decoding apparatus 20 may predict the current block 102 by synthesizing the sample value of the reference block 104 included in the previous picture 103 of the second layer and the residual component of the reference block 106 included in the current picture 105 of the first layer.

Next, the multilayer video decoding apparatus 20 may reconstruct the current block 102 by synthesizing a predicted sample value of the current block 102 and a different value between residual components which is obtained from a bitstream.

FIG. 8B illustrates an example in which the multilayer video decoding apparatus 20 performs residual prediction, according to another embodiment.

In FIG. 8B, when the multilayer video decoding apparatus 20 performs temporal-direction prediction, the multilayer video decoding apparatus 20 may obtain a sample value of a reference block 114 included in a previous picture 113 of a second layer, the reference block 114 being indicated by a motion vector 119 of a current block 112 included in a current picture 111 of the second layer. Also, the multilayer video decoding apparatus 20 may apply (119-1) a motion vector 119 to a reference block 116 included in a current picture 115 of a first layer, the reference block 116 being indicated by a disparity vector 121 of the current block 112 of the second layer and thus may obtain a residual component of a reference block 118 included in a previous picture 117 of the first layer, the reference block 118 being indicated by the motion vector 119. Then, the multilayer video decoding apparatus 20 may predict the current block 112 by synthesizing a sample value of the reference block 114 included in the previous picture 113 of the second layer and the residual component of the reference block 118 included in the previous picture 117 of the first layer.

Next, the multilayer video decoding apparatus 20 may reconstruct the current block 112 by synthesizing a predicted sample value of the current block 112 and a different value between residual components which is obtained from a bitstream.

In FIG. 8B, in order to perform residual prediction on a current block, it is required for the multilayer video decoding apparatus 20 to access three reference blocks in every reference list of the current block. In particular, when the residual prediction is bi-directionally performed, it is required for the multilayer video decoding apparatus 20 to access five through six reference blocks with respect to the current block.

Accordingly, a large bandwidth of a memory is required, and in order to decrease it, a method of performing the residual prediction only when a block size is greater than a predetermined block size may be considered.

For example, the multilayer video decoding apparatus 20 may perform the residual prediction when a size of the current block is greater than 8×8. That is, when the size of the current block is equal to or less than 8×8, the multilayer video decoding apparatus 20 may not perform the residual prediction.

Alternatively, when the size of the current block is equal to or less than 8×8, the multilayer video decoding apparatus 20 may not perform the residual prediction on a chroma component but may perform the residual prediction on a luma component.

Alternatively, when the multilayer video decoding apparatus 20 performs temporal-direction prediction, if the size of the current block is equal to or less than 8×8, the multilayer video decoding apparatus 20 may not perform the residual prediction on the chroma component but may perform the residual prediction on the luma component.

Also, when the multilayer video decoding apparatus 20 performs the residual prediction in a view direction, if the size of the current block is equal to or less than 8×8, the multilayer video decoding apparatus 20 may not perform the residual prediction on both the chroma component and the luma component.

FIG. 9 is a flowchart of a method of determining whether to perform residual prediction by taking into account a size of a current block, the method being performed by the multilayer video decoding apparatus 20, according to an embodiment.

In operation S81, the multilayer video decoding apparatus 20 may determine whether the size of the current block is greater than 8×8. That is, when the size of the current block is expressed as a binary logarithm log 2CbSize by calculating log 2 of a size CbSize of the current block, the multilayer video decoding apparatus 20 may determine whether or not a log value of the size of the current block is greater than 3.

In operation S82, when the log value of the size of the current block is greater than 3 (S81-Y), the multilayer video decoding apparatus 20 may perform the residual prediction. On the other hand, when the log value of the size of the current block is equal to or less than 3 (S81-N), the multilayer video decoding apparatus 20 may not perform the residual prediction.

The method described with reference to FIGS. 8A through 9 is described with respect to the multilayer video decoding apparatus 20 and may also be applied to the multilayer video encoding apparatus 10.

As described above, the multilayer video encoding apparatus 10 according to various embodiments and the multilayer video decoding apparatus 20 according to various embodiments may spilt blocks of video data into coding units having a tree structure, and coding units, prediction units, and transformation units may be used for inter-layer prediction or inter prediction of coding units. Hereinafter, with reference to FIGS. 10 through 22, a video encoding method, a video encoding apparatus, a video decoding method, and a video decoding apparatus based on coding units having a tree structure and transformation units according to various embodiments will be described.

In principle, during encoding and decoding processes for a multilayer video, encoding and decoding processes for first layer images and encoding and decoding processes for second layer images are separately performed. That is, when inter-layer prediction is performed on a multilayer video, encoding and decoding results with respect to single-layer videos may be mutually referred to, but separate encoding and decoding processes are performed on the single-layer videos.

Accordingly, since video encoding and decoding processes based on coding units having a tree structure as described below with reference to FIGS. 10 through 22 for convenience of description are video encoding and decoding processes for processing a single-layer video, only inter prediction and motion compensation are performed. However, as described above with reference to FIGS. 1A through 9, in order to encode and decode a video stream, inter-layer prediction and compensation are performed on base view images and second layer images.

Accordingly, in order for the encoder 12 of the multilayer video encoding apparatus 10 according to various embodiments to encode a multilayer video based on coding units having a tree structure, the multilayer video encoding apparatus 10 may include as many video encoding apparatuses 100 of FIG. 10 as the number of layers of the multilayer video so as to perform video encoding according to each single-layer video, thereby controlling each video encoding apparatus 100 to encode an assigned single-layer video. Also, the multilayer video encoding apparatus 10 may perform inter-view prediction by using encoding results of individual single viewpoints of each video encoding apparatus 100. Accordingly, the encoder 12 of the multilayer video encoding apparatus 10 may generate a base view video stream and a second layer video stream, which include encoding results according to layers.

Similarly, in order for the decoder 24 of the multilayer video decoding apparatus 20 according to various embodiments to decode a multilayer video based on coding units having a tree structure, the multilayer video decoding apparatus 20 may include as many video decoding apparatuses 200 of FIG. 11 as the number of layers of the multilayer video so as to perform video decoding according to layers with respect to a received first layer video stream and a received second layer video stream, thereby controlling each video decoding apparatus 200 to decode an assigned single-layer video. Also, the multilayer video decoding apparatus 20 may perform inter-layer compensation by using a decoding result of an individual single layer of each video decoding apparatus 200. Accordingly, the decoder 24 of the multilayer video decoding apparatus 20 may generate first layer images and second layer images that are reconstructed according to layers.

FIG. 10 is a block diagram of the video encoding apparatus based on coding units according to a tree structure 100, according to an embodiment.

The video encoding apparatus involving video prediction based on coding units according to a tree structure 100 according to an embodiment includes a coding unit determiner 120 and an output unit 130. Hereinafter, for convenience of description, the video encoding apparatus involving video prediction based on coding units according to a tree structure 100 will be abbreviated to the ‘video encoding apparatus 100’.

The coding unit determiner 120 may split a current picture based on a largest coding unit that is a coding unit having a maximum size for the current picture of an image. If the current picture is larger than the largest coding unit, image data of the current picture may be split into the at least one largest coding unit. The largest coding unit according to various embodiments may be a data unit having a size of 32×32, 64×64, 128×128, 256×256, etc., wherein a shape of the data unit is a square having a width and length in squares of 2.

A coding unit according to various embodiments may be characterized by a maximum size and a depth. The depth denotes the number of times the coding unit is spatially split from the largest coding unit, and as the depth deepens, deeper coding units according to depths may be split from the largest coding unit to a smallest coding unit. A depth of the largest coding unit is an uppermost depth and a depth of the smallest coding unit is a lowermost depth. Since a size of a coding unit corresponding to each depth decreases as the depth of the largest coding unit deepens, a coding unit corresponding to an upper depth may include a plurality of coding units corresponding to lower depths.

As described above, the image data of the current picture is split into the largest coding units according to a maximum size of the coding unit, and each of the largest coding units may include deeper coding units that are split according to depths. Since the largest coding unit according to various embodiments is split according to depths, the image data of a spatial domain included in the largest coding unit may be hierarchically classified according to depths.

A maximum depth and a maximum size of a coding unit, which limit the total number of times a height and a width of the largest coding unit are hierarchically split, may be predetermined.

The coding unit determiner 120 encodes at least one split region obtained by splitting a region of the largest coding unit according to depths, and determines a depth to output a finally encoded image data according to the at least one split region. In other words, the coding unit determiner 120 determines a final depth by encoding the image data in the deeper coding units according to depths, according to the largest coding unit of the current picture, and selecting a depth having the minimum encoding error. The determined final depth and the encoded image data according to the determined coded depth are output to the output unit 130.

The image data in the largest coding unit is encoded based on the deeper coding units corresponding to at least one depth equal to or below the maximum depth, and results of encoding the image data are compared based on each of the deeper coding units. A depth having the minimum encoding error may be selected after comparing encoding errors of the deeper coding units. At least one final depth may be selected for each largest coding unit.

The size of the largest coding unit is split as a coding unit is hierarchically split according to depths, and as the number of coding units increases. Also, even if coding units correspond to the same depth in one largest coding unit, it is determined whether to split each of the coding units corresponding to the same depth to a lower depth by measuring an encoding error of the image data of the each coding unit, separately. Accordingly, even when image data is included in one largest coding unit, the encoding errors may differ according to regions in the one largest coding unit, and thus the final depths may differ according to regions in the image data. Thus, one or more final depths may be determined in one largest coding unit, and the image data of the largest coding unit may be divided according to coding units of at least one final depth.

Accordingly, the coding unit determiner 120 according to various embodiments may determine coding units having a tree structure included in the largest coding unit. The ‘coding units having a tree structure’ according to various embodiments include coding units corresponding to a depth determined to be the final depth, from among all deeper coding units included in the largest coding unit. A coding unit of a final depth may be hierarchically determined according to depths in the same region of the largest coding unit, and may be independently determined in different regions. Similarly, a final depth in a current region may be independently determined from a final depth in another region.

A maximum depth according to various embodiments is an index related to the number of splitting times from a largest coding unit to a smallest coding unit. A first maximum depth according to various embodiments may denote the total number of splitting times from the largest coding unit to the smallest coding unit. A second maximum depth according to various embodiments may denote the total number of depth levels from the largest coding unit to the smallest coding unit. For example, when a depth of the largest coding unit is 0, a depth of a coding unit, in which the largest coding unit is split once, may be set to 1, and a depth of a coding unit, in which the largest coding unit is split twice, may be set to 2. In this case, if the smallest coding unit is a coding unit in which the largest coding unit is split four times, depth levels of depths 0, 1, 2, 3, and 4 exist, and thus the first maximum depth may be set to 4, and the second maximum depth may be set to 5.

Prediction encoding and transformation may be performed according to the largest coding unit. The prediction encoding and the transformation are also performed based on the deeper coding units according to a depth equal to or depths less than the maximum depth, according to the largest coding unit.

Since the number of deeper coding units increases whenever the largest coding unit is split according to depths, encoding, including the prediction encoding and the transformation, is performed on all of the deeper coding units generated as the depth deepens. For convenience of description, the prediction encoding and the transformation will now be described based on a coding unit of a current depth, in a largest coding unit.

The video encoding apparatus 100 according to various embodiments may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the largest coding unit, the prediction encoding may be performed based on a coding unit corresponding to a final depth according to various embodiments, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition mode according to various embodiments may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a minimum encoding error.

The video encoding apparatus 100 according to various embodiments may also perform the transformation on the image data in a coding unit based not only on the coding unit for encoding the image data, but also based on a data unit that is different from the coding unit. In order to perform the transformation in the coding unit, the transformation may be performed based on a transformation unit having a size less than or equal to the coding unit. For example, the transformation unit may include a data unit for an intra mode and a transformation unit for an inter mode.

The transformation unit in the coding unit may be recursively split into smaller sized regions in a manner similar to that in which the coding unit is split according to the tree structure, according to various embodiments. Thus, residual data in the coding unit may be split according to the transformation unit having the tree structure according to transformation depths.

A transformation depth indicating the number of splitting times to reach the transformation unit by splitting the height and width of the coding unit may also be set in the transformation unit according to various embodiments. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. That is, the transformation unit having the tree structure may be set according to the transformation depths.

Split information according to depths requires not only information about a depth, but also about information related to prediction encoding and transformation. Accordingly, the coding unit determiner 120 not only determines a depth having a minimum encoding error, but also determines a partition mode of splitting a prediction unit into a partition, a prediction mode according to prediction units, and a size of a transformation unit for transformation.

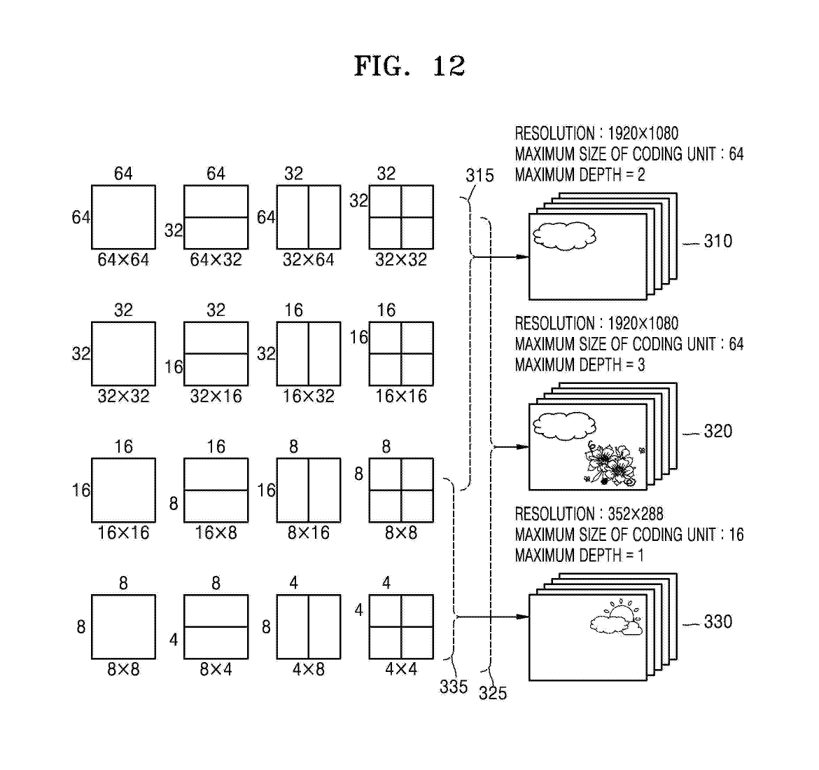

Coding units according to a tree structure in a largest coding unit and methods of determining a prediction unit/partition, and a transformation unit, according to various embodiments, will be described in detail below with reference to FIGS. 12 through 22.

The coding unit determiner 120 may measure an encoding error of deeper coding units according to depths by using Rate-Distortion Optimization based on Lagrangian multipliers.

The output unit 130 outputs the image data of the largest coding unit, which is encoded based on the at least one depth determined by the coding unit determiner 120, and split information according to the depth, in bitstreams.

The encoded image data may be obtained by encoding residual data of an image.

The split information according to depth may include information about the depth, about the partition mode in the prediction unit, about the prediction mode, and about split of the transformation unit.

The information about the final depth may be defined by using split information according to depths, which indicates whether encoding is performed on coding units of a lower depth instead of a current depth. If the current depth of the current coding unit is a depth, the current coding unit is encoded, and thus the split information may be defined not to split the current coding unit to a lower depth. On the other hand, if the current depth of the current coding unit is not the depth, the encoding is performed on the coding unit of the lower depth, and thus the split information may be defined to split the current coding unit to obtain the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one largest coding unit, and split information is determined for a coding unit of a depth, at least one piece of split information may be determined for one largest coding unit. Also, a depth of the image data of the largest coding unit may be different according to locations since the image data is hierarchically split according to depths, and thus a depth and split information may be set for the image data.

Accordingly, the output unit 130 according to various embodiments may assign a corresponding depth and encoding information about an encoding mode to at least one of the coding unit, the prediction unit, and a minimum unit included in the largest coding unit.

The minimum unit according to various embodiments is a square data unit obtained by splitting the smallest coding unit constituting the lowermost depth by 4. Alternatively, the minimum unit according to various embodiments may be a maximum square data unit that may be included in all of the coding units, prediction units, partition units, and transformation units included in the largest coding unit.

For example, the encoding information output by the output unit 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit allowed with respect to a current video, and information about a minimum size of the transformation unit may also be output through a header of a bitstream, a sequence parameter set, or a picture parameter set. The output unit 130 may encode and output reference information related to prediction, motion information, and slice type information.

In the video encoding apparatus 100 according to the simplest embodiment, the deeper coding unit may be a coding unit obtained by dividing a height or width of a coding unit of an upper depth, which is one layer above, by two. That is, when the size of the coding unit of the current depth is 2N×2N, the size of the coding unit of the lower depth is N×N. Also, a current coding unit having a size of 2N×2N may maximally include four lower-depth coding units each having a size of N×N.

Accordingly, the video encoding apparatus 100 may form the coding units having the tree structure by determining coding units having an optimum shape and an optimum size for each largest coding unit, based on the size of the largest coding unit and the maximum depth determined considering characteristics of the current picture. Also, since encoding may be performed on each largest coding unit by using any one of various prediction modes and transformations, an optimum encoding mode may be determined by taking into account characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100 according to various embodiments, image compression efficiency may be increased since a coding unit is adjusted while considering characteristics of an image while increasing a maximum size of a coding unit while considering a size of the image.

The multilayer video encoding apparatus 10 described above with reference to FIG. 1A may include as many video encoding apparatuses 100 as the number of layers, in order to encode single-layer images according to layers of a multilayer video.

When the video encoding apparatus 100 encodes first layer images, the coding unit determiner 120 may determine, for each largest coding unit, a prediction unit for inter-prediction according to coding units having a tree structure, and perform inter-prediction according to prediction units.

Even when the video encoding apparatus 100 encodes second layer images, the coding unit determiner 120 may determine, for each largest coding unit, coding units and prediction units having a tree structure, and perform inter-prediction according to prediction units.

The video encoding apparatus 100 may encode a luminance difference to compensate for a luminance difference between a first layer image and a second layer image. However, whether to perform luminance may be determined according to an encoding mode of a coding unit. For example, luminance compensation may be performed only on a prediction unit having a size of 2N×2N.

FIG. 11 is a block diagram of the video decoding apparatus based on coding units according to a tree structure 200, according to various embodiments.

The video decoding apparatus that involves video prediction based on coding units having a tree structure 200 according to an embodiment includes a receiver 210, an image data and encoding information extractor 220, and an image data decoder 230. For convenience of description, the video decoding apparatus that involves video prediction based on coding units having a tree structure 200 according to an embodiment will be abbreviated to the ‘video decoding apparatus 200’.

Definitions of various terms, such as a coding unit, a depth, a prediction unit, a transformation unit, and various split information, for decoding operations of the video decoding apparatus 200 according to various embodiments are identical to those described with reference to FIG. 10 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each largest coding unit, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a final depth and split information for the coding units having a tree structure according to each largest coding unit, from the parsed bitstream. The extracted final depth and split information are output to the image data decoder 230. That is, the image data in a bit stream is split into the largest coding unit so that the image data decoder 230 decodes the image data for each largest coding unit.

A depth and split information according to the largest coding unit may be set for at least one piece of depth information, and split information may include information about a partition mode of a corresponding coding unit, about a prediction mode, and about split of a transformation unit. Also, split information according to depths may be extracted as the information about a depth.

The depth and the split information according to each largest coding unit extracted by the image data and encoding information extractor 220 is a depth and split information determined to generate a minimum encoding error when an encoder, such as the video encoding apparatus 100 according to various embodiments, repeatedly performs encoding for each deeper coding unit according to depths according to each largest coding unit. Accordingly, the video decoding apparatus 200 may reconstruct an image by decoding the image data according to a coded depth and an encoding mode that generates the minimum encoding error.

Since encoding information about a depth and an encoding mode according to various embodiments may be assigned to a predetermined data unit from among a corresponding coding unit, a prediction unit, and a minimum unit, the image data and encoding information extractor 220 may extract the depth and the split information according to the predetermined data units. If the depth and the split information of a corresponding largest coding unit is recorded according to predetermined data units, the predetermined data units to which the same depth and the same split information is assigned may be inferred to be the data units included in the same largest coding unit.

The image data decoder 230 may reconstruct the current picture by decoding the image data in each largest coding unit based on the depth and the split information according to the largest coding units. That is, the image data decoder 230 may decode the encoded image data based on the extracted information about the partition mode, the prediction mode, and the transformation unit for each coding unit from among the coding units having the tree structure included in each largest coding unit. A decoding process may include a prediction including intra prediction and motion compensation, and an inverse transformation.

The image data decoder 230 may perform intra prediction or motion compensation according to a partition and a prediction mode of each coding unit, based on the information about the partition mode and the prediction mode of the prediction unit of the coding unit according to depths.

In addition, the image data decoder 230 may read information about a transformation unit according to a tree structure for each coding unit so as to perform inverse transformation based on transformation units for each coding unit, for inverse transformation for each largest coding unit. Via the inverse transformation, a pixel value of a spatial domain of the coding unit may be reconstructed.

The image data decoder 230 may determine a depth of a current largest coding unit by using split information according to depths. If the split information indicates that image data is no longer split in the current depth, the current depth is a depth. Accordingly, the image data decoder 230 may decode encoded data in the current largest coding unit by using the information about the partition mode of the prediction unit, the prediction mode, and the size of the transformation unit.

That is, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

The multilayer video decoding apparatus 20 described above with reference to FIG. 2A may include the number of video decoding apparatuses 200 as much as the number of viewpoints, so as to reconstruct first layer images and second layer images by decoding a received first layer image stream and a received second layer image stream.

When the first layer image stream is received, the image data decoder 230 of the video decoding apparatus 200 may split samples of first layer images extracted from the first layer image stream by the image data and encoding information extractor 220 into coding units having a tree structure. The image data decoder 230 may reconstruct the first layer images by performing motion compensation according to prediction units for inter prediction, on the coding units having the tree structure obtained by splitting the samples of the first layer images.

When the second layer image stream is received, the image data decoder 230 of the video decoding apparatus 200 may split samples of second layer images extracted from the second layer image stream by the image data and encoding information extractor 220 into coding units having a tree structure. The image data decoder 230 may reconstruct the second layer images by performing motion compensation according to prediction units for inter prediction, on the coding units obtained by splitting the samples of the second layer images.

The extractor 220 may obtain information related to a luminance error from a bitstream so as to compensate for a luminance difference between a first layer image and a second layer image. However, whether to perform luminance may be determined according to an encoding mode of a coding unit. For example, luminance compensation may be performed only on a prediction unit having a size of 2N×2N.

Thus, the video decoding apparatus 200 may obtain information about at least one coding unit that generates the minimum encoding error when encoding is recursively performed for each largest coding unit, and may use the information to decode the current picture. That is, the coding units having the tree structure determined to be the optimum coding units in each largest coding unit may be decoded.

Accordingly, even if image data has high resolution and a large amount of data, the image data may be efficiently decoded and reconstructed by using a size of a coding unit and an encoding mode, which are adaptively determined according to characteristics of the image data, by using optimum split information received from an encoder.

FIG. 12 is a diagram for describing a concept of coding units, according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 12 denotes a total number of splits from a largest coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a largest coding unit having a long axis size of 64, and coding units having long axis sizes of 32 and 16 since depths are deepened to two layers by splitting the largest coding unit twice. Since the maximum depth of the video data 330 is 1, coding units 335 of the video data 330 may include a largest coding unit having a long axis size of 16, and coding units having a long axis size of 8 since depths are deepened to one layer by splitting the largest coding unit once.

Since the maximum depth of the video data 320 is 3, coding units 325 of the video data 320 may include a largest coding unit having a long axis size of 64, and coding units having long axis sizes of 32, 16, and 8 since the depths are deepened to 3 layers by splitting the largest coding unit three times. As a depth deepens, detailed information may be precisely expressed.

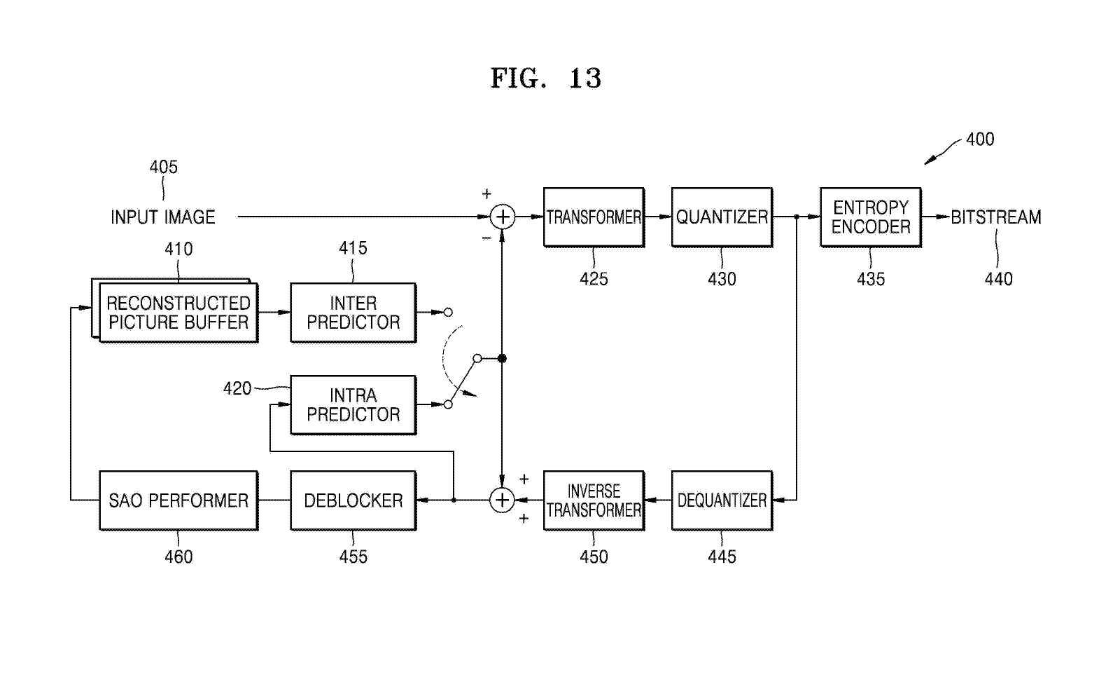

FIG. 13 is a block diagram of an image encoder 400 based on coding units, according to various embodiments.

The image encoder 400 according to various embodiments performs operations of the coding unit determiner 120 of the video encoding apparatus 100 to encode image data. In other words, an intra predictor 420 performs intra prediction on coding units in an intra mode, from among a current frame 405, per prediction unit, and an inter predictor 415 performs inter prediction on coding units in an inter mode by using the current image 405 and a reference image obtained by a restored picture buffer 410, per prediction unit. The current picture 405 may be split into largest coding units, and then the largest coding units may be sequentially encoded. Here, the encoding may be performed on coding units split in a tree structure from the largest coding unit.

Residual data is generated by subtracting prediction data of a coding unit of each mode output from the intra predictor 420 or the inter predictor 415 from data of the current image 405 to be encoded, and the residual data is output as a quantized transformation coefficient through a transformer 425 and a quantizer 430 per transformation unit. The quantized transformation coefficient is restored to residual data in a spatial domain through a dequantizer 445 and an inverse transformer 450. The residual data in the spatial domain is added to the prediction data of the coding unit of each mode output from the intra predictor 420 or the inter predictor 415 to be restored as data in a spatial domain of the coding unit of the current image 405. The data in the spatial domain passes through a deblocker 455 and a sample adaptive offset (SAO) performer 460 and thus a restored image is generated. The restored image is stored in the restored picture buffer 410. Restored images stored in the restored picture buffer 410 may be used as a reference image for inter prediction of another image. The quantized transformation coefficient obtained through the transformer 425 and the quantizer 430 may be output as a bitstream 440 through an entropy encoder 435.

In order for the image encoder 400 according to various embodiments to be applied in the video encoding apparatus 100, components of the image encoder 400, i.e., the inter predictor 415, the intra predictor 420, the transformer 425, the quantizer 430, the entropy encoder 435, the dequantizer 445, the inverse transformer 450, the deblocker 455, and the SAO performer 460 perform operations based on each coding unit among coding units having a tree structure per largest coding unit.

In particular, the intra predictor 420 and the inter predictor 415 determine partitions and a prediction mode of each coding unit from among the coding units having a tree structure while considering the maximum size and the maximum depth of a current largest coding unit, and the transformer 425 may determine whether to split a transformation unit according to a quad-tree in each coding unit from among the coding units having the tree structure.

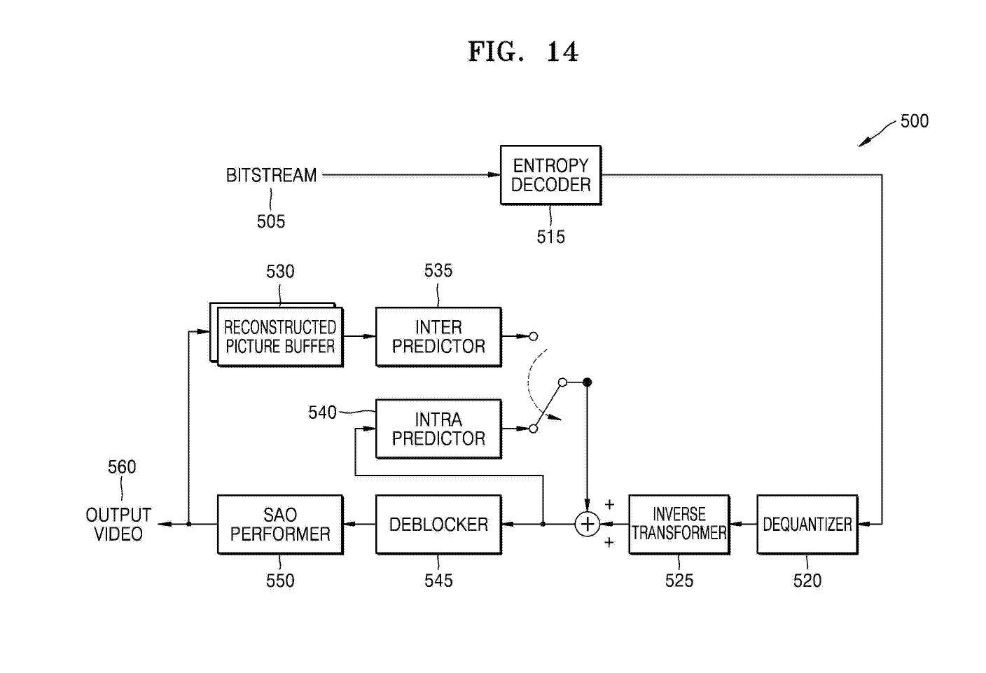

FIG. 14 is a block diagram of an image decoder 500 based on coding units, according to various embodiments.

An entropy decoder 515 parses encoded image data that is to be decoded and encoding information required for decoding from a bitstream 505. The encoded image data is a quantized transformation coefficient, and a dequantizer 520 and an inverse transformer 525 restores residual data from the quantized transformation coefficient.

An intra predictor 540 performs intra prediction on a coding unit in an intra mode according to prediction units. An inter predictor performs inter prediction on a coding unit in an inter mode from a current image according to prediction units, by using a reference image obtained by a restored picture buffer 530.

Data in a spatial domain of coding units of the current image is restored by adding the residual data and the prediction data of a coding unit of each mode through the intra predictor and the inter predictor 535, and the data in the spatial domain may be output as a restored image through a deblocker 545 and an SAO performer 550. Also, restored images stored in the restored picture buffer 530 may be output as reference images.

In order to decode the image data in the image data decoder 230 of the video decoding apparatus 200, operations after the entropy decoder 515 of the image decoder 500 according to various embodiments may be performed.

In order for the image decoder 500 to be applied in the video decoding apparatus 200 according to various embodiments, components of the image decoder 500, i.e., the entropy decoder 515, the dequantizer 520, the inverse transformer 525, the intra predictor 540, the inter predictor 535, the deblocker 545, and the SAO performer 550 may perform operations based on coding units having a tree structure for each largest coding unit.

In particular, the intra predictor 540 and the inter predictor 535 determine a partition mode and a prediction mode according to each of coding units having a tree structure, and the inverse transformer 525 may determine whether to split a transformation unit according to a quad-tree structure per coding unit.

An encoding operation of FIG. 13 and a decoding operation of FIG. 14 are respectively a video stream encoding operation and a video stream decoding operation in a single layer. Accordingly, when the encoder 12 of FIG. 1A encodes a video stream of at least two layers, the video encoding apparatus 100 of FIG. 1A may include as many image encoder 400 as the number of layers. Similarly, when the decoder 24 of FIG. 2A decodes a video stream of at least two layers, the video decoding apparatus 200 of FIG. 2A may include as many image decoders 500 as the number of layers.

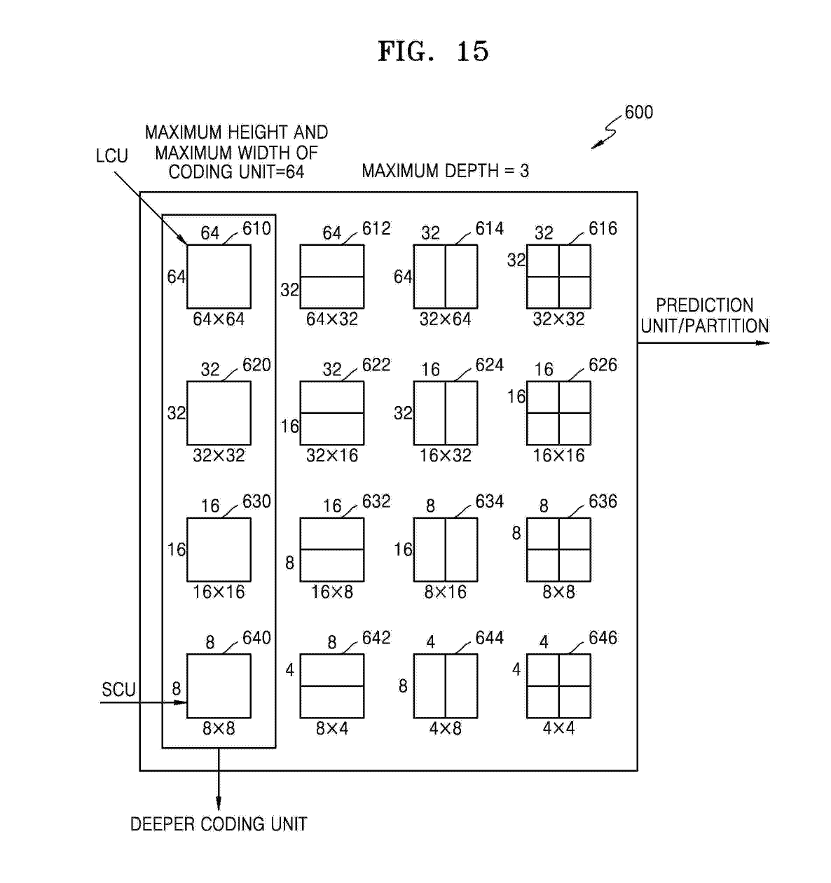

FIG. 15 is a diagram illustrating coding units and partitions, according to various embodiments.

The video encoding apparatus 100 according to various embodiments and the video decoding apparatus 200 according to various embodiments use hierarchical coding units so as to consider characteristics of an image. A maximum height, a maximum width, and a maximum depth of coding units may be adaptively determined according to the characteristics of the image, or may be variously set according to user requirements. Sizes of deeper coding units according to depths may be determined according to the predetermined maximum size of the coding unit.

In a hierarchical structure 600 of coding units according to various embodiments, the maximum height and the maximum width of the coding units are each 64, and the maximum depth is 3. In this case, the maximum depth refers to a total number of times the coding unit is split from the largest coding unit to the smallest coding unit. Since a depth deepens along a vertical axis of the hierarchical structure 600 of coding units according to various embodiments, a height and a width of the deeper coding unit are each split. Also, a prediction unit and partitions, which are bases for prediction encoding of each deeper coding unit, are shown along a horizontal axis of the hierarchical structure 600.

That is, a coding unit 610 is a largest coding unit in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3. The coding unit 640 having a size of 8×8 and a depth of 3 is a smallest coding unit.

The prediction unit and the partitions of a coding unit are arranged along the horizontal axis according to each depth. That is, if the coding unit 610 having a size of 64×64 and a depth of 0 is a prediction unit, the prediction unit may be split into partitions included in the encoding unit 610 having a size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620 having the size of 32×32, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630 having the size of 16×16, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640 having the size of 8×8, i.e. a partition having a size of 8×8 included in the coding unit 640, partitions 642 having a size of 8×4, partitions 644 having a size of 4×8, and partitions 646 having a size of 4×4.

In order to determine the depth of the largest coding unit 610, the coding unit determiner 120 of the video encoding apparatus 100 according to various embodiments performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a minimum encoding error may be selected for the current depth by performing encoding for each prediction unit in the coding units corresponding to the current depth, along the horizontal axis of the hierarchical structure 600. Alternatively, the minimum encoding error may be searched for by comparing the minimum encoding errors according to depths, by performing encoding for each depth as the depth deepens along the vertical axis of the hierarchical structure 600. A depth and a partition having the minimum encoding error in the largest coding unit 610 may be selected as the depth and a partition mode of the largest coding unit 610.

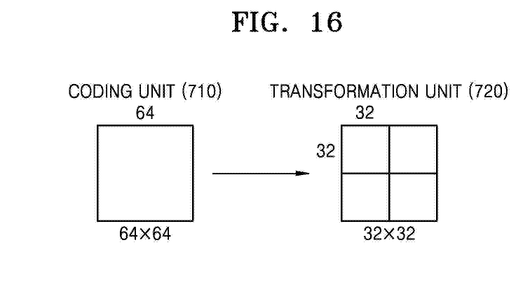

FIG. 16 is a diagram for describing a relationship between a coding unit and transformation units, according to various embodiments.

The video encoding apparatus 100 according to an embodiment or the video decoding apparatus 200 according to an embodiment encodes or decodes an image according to coding units having sizes less than or equal to a largest coding unit for each largest coding unit. Sizes of transformation units for transformation during encoding may be selected based on data units that are not larger than a corresponding coding unit.

For example, in the video encoding apparatus 100 according to various embodiments or the video decoding apparatus 200 according to various embodiments, if a size of a coding unit 710 is 64×64, transformation may be performed by using a transformation unit 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the minimum coding error may be selected.

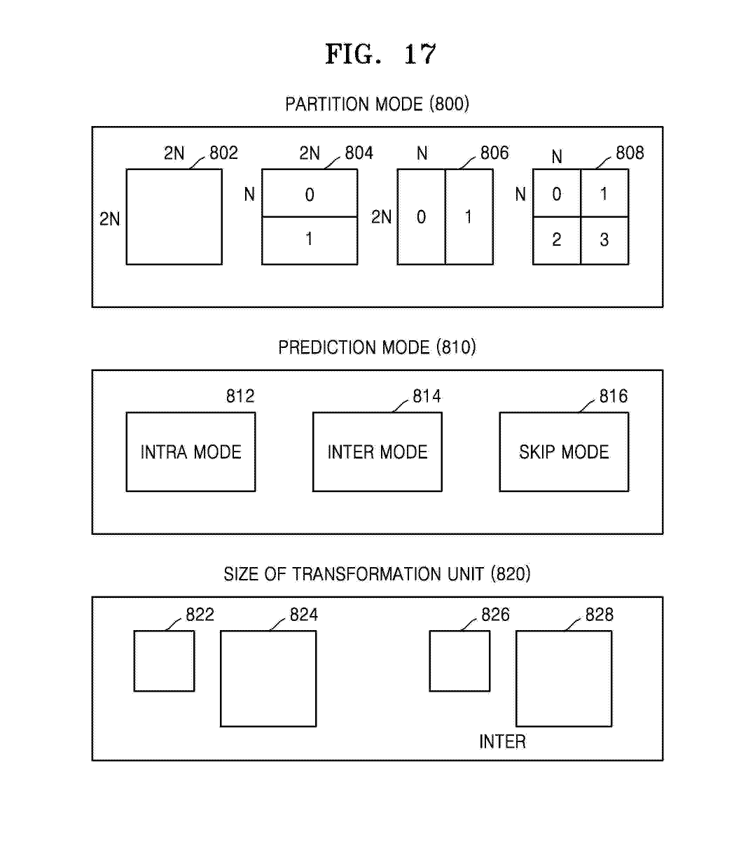

FIG. 17 illustrates a plurality of pieces of encoding information, according to various embodiments.

The output unit 130 of the video encoding apparatus 100 according to various embodiments may encode and transmit partition mode information 800, prediction mode information 810, and transformation unit size information 820 for each coding unit corresponding to a depth, as split information.

The partition mode information 800 indicates information about a shape of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. In this case, the partition mode information 800 about a partition type of a current coding unit is set to indicate one of the partition 804 having a size of 2N×N, the partition 806 having a size of N×2N, and the partition 808 having a size of N×N.

The prediction mode information 810 indicates a prediction mode of each partition. For example, the prediction mode information 810 may indicate a mode of prediction encoding performed on a partition indicated by the partition mode information 800, i.e., an intra mode 812, an inter mode 814, or a skip mode 816.

The transformation unit size information 820 indicates a transformation unit to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 according to various embodiments may extract and use the partition mode information 800, the prediction mode information 810, and the transformation unit size information 820 for decoding, according to each deeper coding unit.

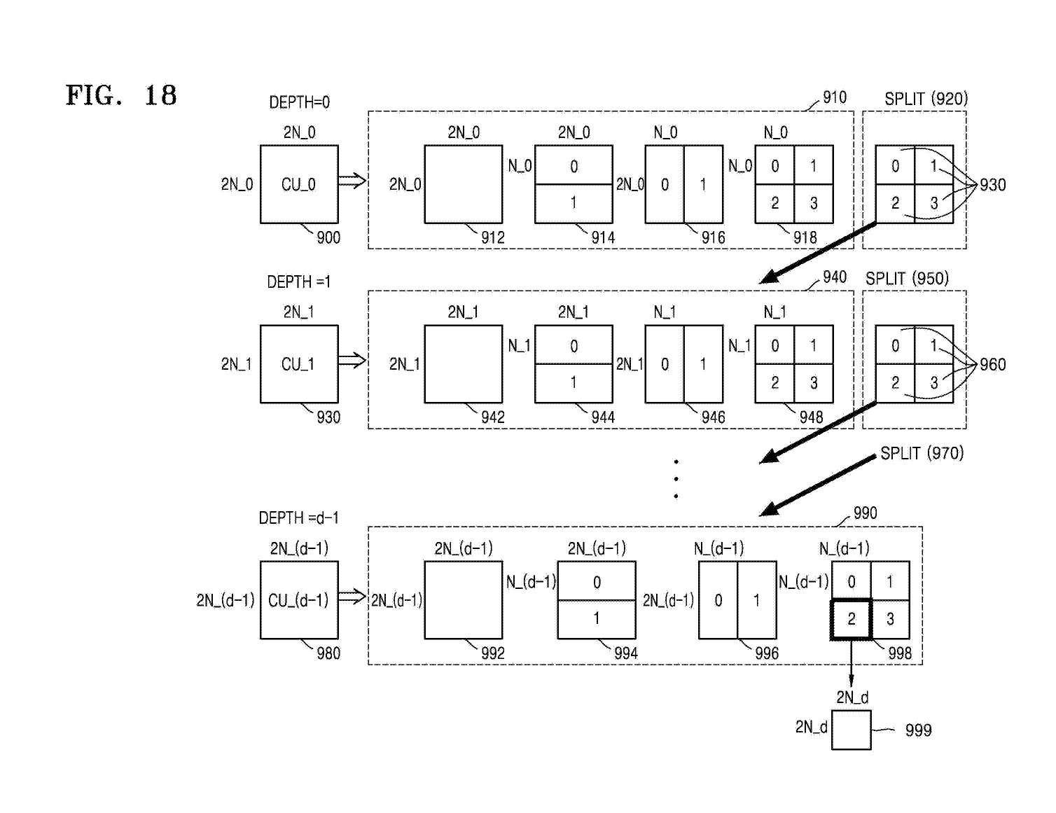

FIG. 18 is a diagram of deeper coding units according to depths, according to various embodiments.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_0×2N_0 may include partitions of a partition mode 912 having a size of 2N_0×2N_0, a partition mode 914 having a size of 2N_0×N_0, a partition mode 916 having a size of N_0×2N_0, and a partition mode 918 having a size of N_0×N_0. FIG. 18 only illustrates the partitions 912 through 918 which are obtained by symmetrically splitting the prediction unit, but a partition mode is not limited thereto, and the partitions of the prediction unit may include asymmetrical partitions, partitions having an arbitrary shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error in one of the partition mode 912 having the size of 2N_0×2N_0, the partition mode 914 having the size of 2N_0×N_0, and the partition mode 916 having the size of N_0×2N_0 is a minimum error, the prediction unit 910 may not be split into a lower depth.

If the encoding error in the partition mode 918 having the size of N_0×N_0 is a minimum error, a depth is changed from 0 to 1 to split the partition mode 918 in operation 920, and encoding is repeatedly performed on coding units 930 in a partition mode having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition mode 942 having a size of 2N_1×2N_1, a partition mode 944 having a size of 2N_1 xN_1, a partition mode 946 having a size of N_1×2N_1, and a partition mode 948 having a size of N_1 xN_1.

If the encoding error in the partition mode 948 having the size of N_1 xN_1 is a minimum error, a depth is changed from 1 to 2 to split the partition mode 948 in operation 950, and encoding is repeatedly performed on coding units 960 having a depth of 2 and a size of N_2 xN_2 so as to search for a minimum encoding error.

When a maximum depth is d, deeper coding units according to depths may be set until when a depth corresponds to d−1, and split information may be set until when a depth corresponds to d−2. That is, when encoding is performed up to when the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition mode 992 having a size of 2N_(d−1)×2N_(d−1), a partition mode 994 having a size of 2N_(d−1)×N_(d−1), a partition mode 996 having a size of N_(d−1)×2N_(d−1), and a partition mode 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes to search for a partition mode having a minimum encoding error.

Even when the partition mode 998 has the minimum encoding error, since a maximum depth is d, a coding unit CU_(d−1) having a depth of d−1 is no longer split to a lower depth, and a depth for the coding units constituting a current largest coding unit 900 is determined to be d−1 and a partition mode of the current largest coding unit 900 may be determined to be N_(d−1)×N_(d−1). Also, since the maximum depth is d, split information for a coding unit 952 having a depth of d−1 is not set.

A data unit 999 may be a ‘minimum unit’ for the current largest coding unit. A minimum unit according to various embodiments may be a square data unit obtained by splitting a smallest coding unit having a lowermost depth by 4. By performing the encoding repeatedly, the video encoding apparatus 100 according to various embodiments may select a depth having the minimum encoding error by comparing encoding errors according to depths of the coding unit 900 to determine a depth, and set a corresponding partition mode and a prediction mode as an encoding mode of the depth.

As such, the minimum encoding errors according to depths are compared in all of the depths of 0, 1, . . . , d−1, d, and a depth having the minimum encoding error may be determined as a depth. The depth, the partition mode of the prediction unit, and the prediction mode may be encoded and transmitted as split information. Also, since a coding unit is split from a depth of 0 to a depth, only split information of the depth is set to 0, and split information of depths excluding the depth is set to 1.

The image data and encoding information extractor 220 of the video decoding apparatus 200 according to various embodiments may extract and use the information about the depth and the prediction unit of the coding unit 900 so as to decode the partition 912. The video decoding apparatus 200 according to various embodiments may determine a depth, in which split information is 0, as a depth by using split information according to depths, and may use split information of the corresponding depth for decoding.

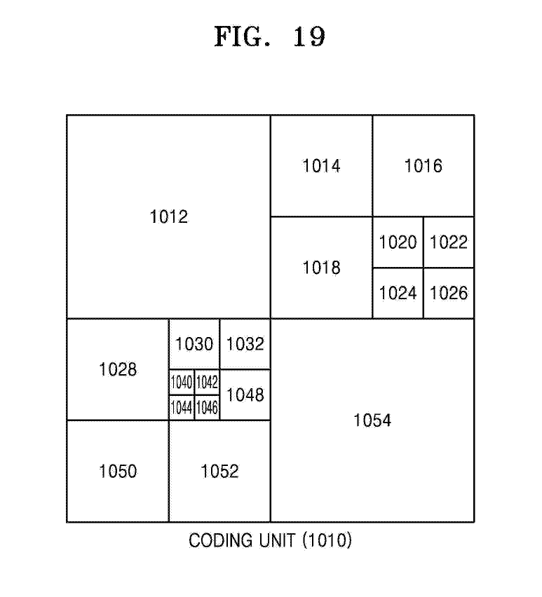

FIGS. 19, 20, and 21 are diagrams for describing a relationship between coding units, prediction units, and transformation units, according to various embodiments.

Coding units 1010 are coding units having a tree structure, according to depths determined by the video encoding apparatus 100 according to various embodiments, in a largest coding unit. Prediction units 1060 are partitions of prediction units of each of coding units according to depths, and transformation units 1070 are transformation units of each of coding units according to depths.

When a depth of a largest coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. That is, partition modes in the coding units 1014, 1022, 1050, and 1054 have a size of 2N×N, partition modes in the coding units 1016, 1048, and 1052 have a size of N×2N, and a partition modes of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are data units different from those in the prediction units 1060 in terms of sizes and shapes. That is, the video encoding and decoding apparatuses 100 and 200 according to various embodiments may perform intra prediction, motion estimation, motion compensation, transformation, and inverse transformation on an individual data unit in the same coding unit.

Accordingly, encoding is recursively performed on each of coding units having a hierarchical structure in each region of a largest coding unit to determine an optimum coding unit, and thus coding units having a recursive tree structure may be obtained. Encoding information may include split information about a coding unit, information about a partition mode, information about a prediction mode, and information about a size of a transformation unit. Table 1 shows the encoding information that may be set by the video encoding and decoding apparatuses 100 and 200 according to various embodiments.

TABLE 1

| | | | | | Split |
|---|---|---|---|---|---|
| Split Information 0 | | | | | Information |
| (Encoding on Coding Unit having Size of 2N × 2N and Current Depth of d) | | | | | 1 |
| Prediction | Partition Mode | | Size of Transformation Unit | | Repeatedly |
| Mode | | | | | Encode |
| Intra | Symmetrical | Asymmetrical | Split Information | Split Information | Coding |
| Inter | Partition | Partition | 0 of | 1 of | Units having |
| Skip | Mode | Mode | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Partition Mode) | |
| | N × N | nR × 2N | | N/2 × N/2 | |
| | | | | (Asymmetrical | |
| | | | | Partition Mode) | |

The output unit 130 of the video encoding apparatus 100 according to various embodiments may output the encoding information about the coding units having a tree structure, and the image data and encoding information extractor 220 of the video decoding apparatus 200 according to various embodiments may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a depth, and thus information about a partition mode, prediction mode, and a size of a transformation unit may be defined for the depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition modes, and the skip mode may be defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1.

The size of the transformation unit may be set to be two types in the intra mode and two types in the inter mode. That is, if split information of the transformation unit is 0, the size of the transformation unit may be 2Nx2N, which is the size of the current coding unit. If the split information of the transformation unit is 1, the transformation units may be obtained by splitting the current coding unit. Also, if a partition mode of the current coding unit having the size of 2N×2N is a symmetrical partition mode, a size of a transformation unit may be N×N, and if the partition type of the current coding unit is an asymmetrical partition mode, the size of the transformation unit may be N/2×N/2.

The encoding information about coding units having a tree structure according to various embodiments may be assigned to at least one of a coding unit corresponding to a depth, a prediction unit, and a minimum unit. The coding unit corresponding to the depth may include at least one of a prediction unit and a minimum unit that have the same encoding information.

Accordingly, it is determined whether adjacent data units are included in the same coding unit corresponding to the depth by comparing a plurality of pieces of encoding information of the adjacent data units. Also, a corresponding coding unit corresponding to a depth is determined by using encoding information of a data unit, and thus a distribution of depths in a largest coding unit may be determined.

Accordingly, if a current coding unit is predicted based on encoding information of adjacent data units, encoding information of data units in deeper coding units adjacent to the current coding unit may be directly referred to and used.

As another example, if a current coding unit is prediction-encoded by referring to adjacent coding units, a data unit that is adjacent to the current coding unit and is in adjacent deeper coding units is searched by using a plurality of pieces of encoding information of the adjacent coding units, in such a manner that the adjacent coding units may be referred to.

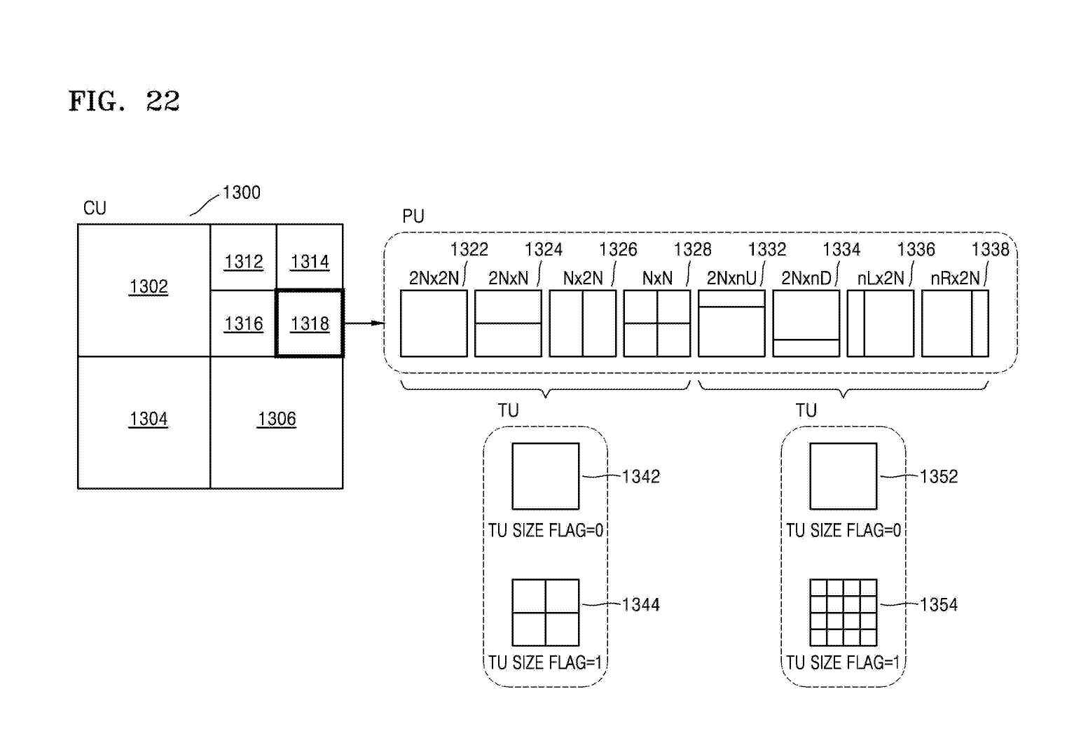

FIG. 22 is a diagram for describing a relationship between a coding unit, a prediction unit, and a transformation unit, according to encoding mode information of Table 1.

A largest coding unit 1300 includes coding units 1302, 1304, 1306, 1312, 1314, 1316, and 1318 of depths. Here, since the coding unit 1318 is a coding unit of a depth, split information may be set to 0. Information about a partition mode of the coding unit 1318 having a size of 2N×2N may be set to be one of a partition mode 1322 having a size of 2N×2N, a partition mode 1324 having a size of 2N×N, a partition mode 1326 having a size of Nx2N, a partition mode 1328 having a size of N×N, a partition mode 1332 having a size of 2N×nU, a partition mode 1334 having a size of 2N×nD, a partition mode 1336 having a size of nLx2N, and a partition mode 1338 having a size of nRx2N.

Transformation unit split information (TU size flag) is a type of a transformation index. A size of a transformation unit corresponding to the transformation index may be changed according to a prediction unit type or a partition mode of the coding unit.

For example, when information about the partition mode is set to be symmetrical, i.e. the partition mode 1322 having a size of 2N×2N, the partition mode 1324 having a size of 2N×N, the partition mode 1326 having a size of Nx2N, or the partition mode 1328 having a size of N×N, a transformation unit 1342 having a size of 2N×2N may be set if the TU size flag of the transformation unit is 0, and a transformation unit 1344 having a size of N×N may be set if the TU size flag is 1.

When the information about the partition mode is set to be asymmetrical, i.e., the partition mode 1332 having a size of 2N×nU, the partition mode 1334 having a size of 2N×nD, the partition mode 1336 having a size of nLx2N, or the partition mode 1338 having a size of nRx2N, a transformation unit 1352 having a size of 2N×2N may be set if the TU size flag is 0, and a transformation unit 1354 having a size of N/2×N/2 may be set if the TU size flag is 1.

Referring to FIG. 22, the TU size flag is a flag having a value or 0 or 1, but the TU size flag according to various embodiments is not limited to a flag of 1 bit, and the transformation unit may be hierarchically split while the TU size flag increases from 0. The TU size flag may be an example of the transformation index.

In this case, the size of the transformation unit that has been actually used may be expressed by using the TU size flag according to various embodiments together with a maximum size of the transformation unit and a minimum size of the transformation unit. The video encoding apparatus 100 according to various embodiments may encode maximum transformation unit size information, minimum transformation unit size information, and maximum TU size flag information. The result of encoding the maximum transformation unit size information, the minimum transformation unit size information, and the maximum TU size flag information may be inserted into an SPS. The video decoding apparatus 200 according to various embodiments may decode video by using the maximum transformation unit size information, the minimum transformation unit size information, and the maximum TU size flag information.

For example, (a) if a size of a current coding unit is 64×64 and a maximum transformation unit size is 32×32, (a−1) then a size of a transformation unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transformation unit size is 32×32, (b−1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and the maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2̂MaxTransformSizelndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizelndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizelndex)’ and ‘MinTransformSize’ may be the current minimum transformation unit size ‘CurrMinTuSize’ that can be determined in the current coding unit.

The maximum transformation unit size RootTuSize according to various embodiments may vary according to a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the present disclosure is not limited thereto.

According to the video encoding method based on coding units having a tree structure as described with reference to FIGS. 10 through 22, image data of a spatial domain is encoded for each coding unit of a tree structure. According to the video decoding method based on coding units having a tree structure, decoding is performed for each largest coding unit to reconstruct image data of a spatial domain. Thus, a picture and a video that is a picture sequence may be reconstructed. The reconstructed video may be reproduced by a reproducing apparatus, may be stored in a storage medium, or may be transmitted through a network.

The embodiments according to the present disclosure may be written as computer programs and may be implemented in general-use digital computers that execute the programs using a non-transitory computer-readable recording medium. Examples of the non-transitory computer-readable recording medium include magnetic storage media (e.g., ROM, floppy discs, hard discs, etc.) and optical recording media (e.g., CD-ROMs, or DVDs).

For convenience of description, the inter-layer video encoding method and/or the video encoding method described above with reference to FIGS. 1A through 20 will be collectively referred to as a ‘video encoding method of the present disclosure’. In addition, the inter-layer video decoding method and/or the video decoding method described above with reference to FIGS. 1A through 22 will be referred to as a ‘video decoding method of the present disclosure’.

Also, a video encoding apparatus including the inter-layer video encoding apparatus 10, the video encoding apparatus 100, or the image encoder 400, which has been described with reference to FIGS. 1A through 22, will be referred to as a ‘video encoding apparatus of the present disclosure’. In addition, a video decoding apparatus including the inter-layer video decoding apparatus 20, the video decoding apparatus 200, or the image decoder 500, which has been descried with reference to FIGS. 1A through 22, will be referred to as a ‘video decoding apparatus of the present disclosure’.

The non-transitory computer-readable recording medium such as a disc 26000 that stores the programs according to various embodiments will now be described in detail.

FIG. 23 is a diagram of a physical structure of the disc 26000 in which a program is stored, according to various embodiments. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000 according to various embodiments, a program that executes the quantization parameter determining method, the video encoding method, and the video decoding method described above may be assigned and stored.

A computer system embodied using the storage medium that stores the program for executing the video encoding method and the video decoding method as described above will now be described with reference to FIG. 24.

FIG. 24 is a diagram of a disc drive 26800 for recording and reading a program by using the disc 26000. A computer system 26700 may store a program that executes at least one of a video encoding method and a video decoding method of the present disclosure, in the disc 26000 via the disc drive 26800. In order to run the program stored in the disc 26000 in the computer system 26700, the program may be read from the disc 26000 and be transmitted to the computer system 26700 by using the disc drive 27000.

The program that executes at least one of a video encoding method and a video decoding method of the present disclosure may be stored not only in the disc 26000 illustrated in FIGS. 23 and 24 but also in a memory card, a ROM cassette, or a solid state drive (SSD).

A system to which the video encoding method and the video decoding method according to the embodiments described above are applied will be described below.

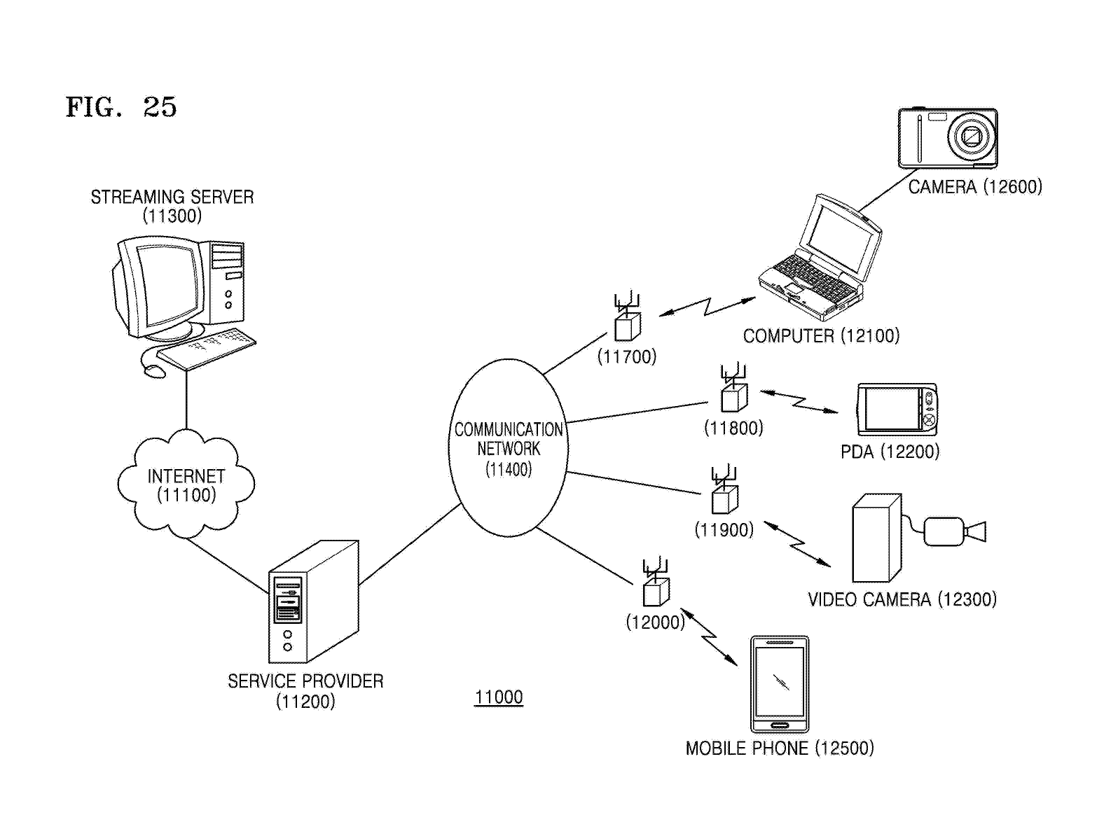

FIG. 25 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as that illustrated in FIG. 25, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded by the camera 12600 or the computer 12100. Software that performs encoding and decoding video may be stored in a non-transitory computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

In the content supply system 11000 according to various embodiments, content data, e.g., content recorded during a concert, which has been recorded by a user using the video camera 12300, the camera 12600, the mobile phone 12500, or another imaging device is encoded and is transmitted to the streaming server 11300. The streaming server 11300 may transmit the encoded content data in a type of a streaming content to other clients that request the content data.

The clients, for example, the computer 12100, the PDA 12200, the video camera 12300, or the mobile phone 12500, are devices capable of decoding the encoded content data. Thus, the content supply system 11000 allows the clients to receive and reproduce the encoded content data. Also, the content supply system 11000 allows the clients to receive the encoded content data and decode and reproduce the encoded content data in real-time, thereby enabling personal broadcasting.

The video encoding apparatus and the video decoding apparatus of the present disclosure may be applied to encoding and decoding operations of the plurality of independent devices included in the content supply system 11000.

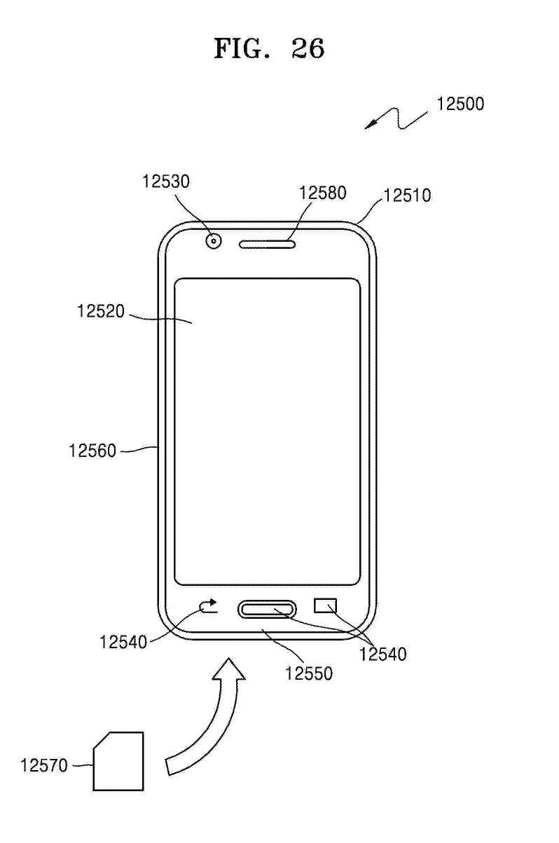

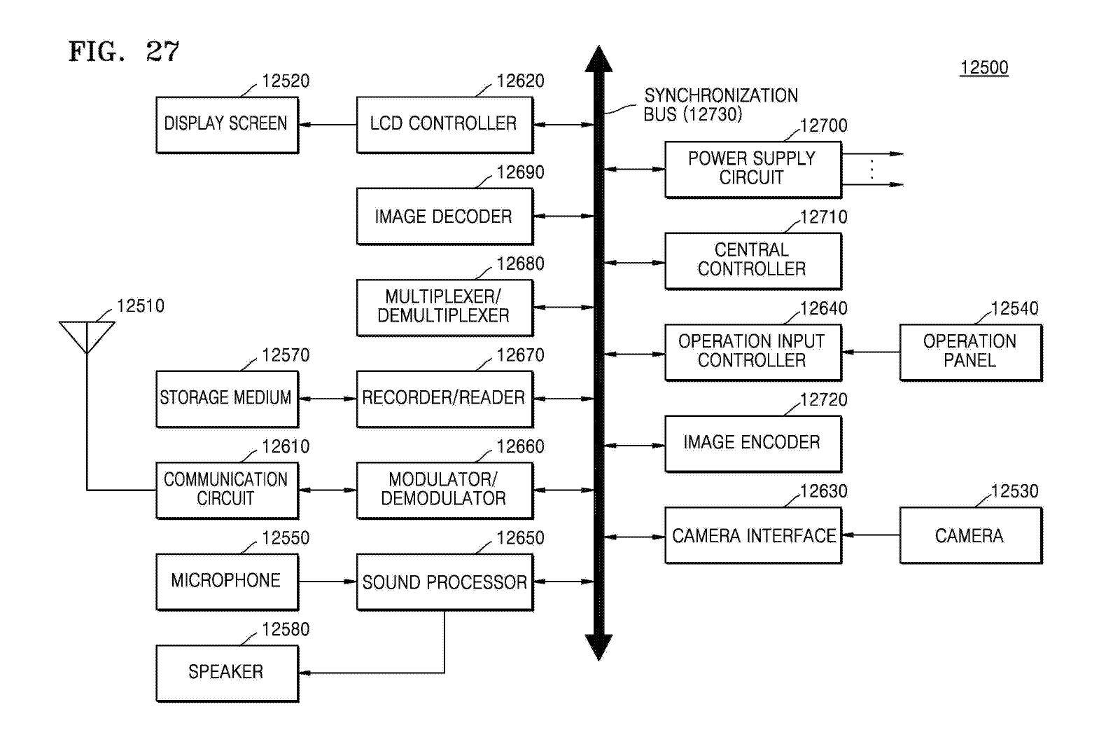

With reference to FIGS. 26 and 27, an embodiment of the mobile phone 12500 included in the content supply system 11000 will now be described in detail.

FIG. 26 illustrates an external structure of the mobile phone 12500 to which the video encoding method and the video decoding method of the present disclosure are applied, according to various embodiments. The mobile phone 12500 may be a smart phone, the functions of which are not limited and a large number of the functions of which may be changed or expanded.

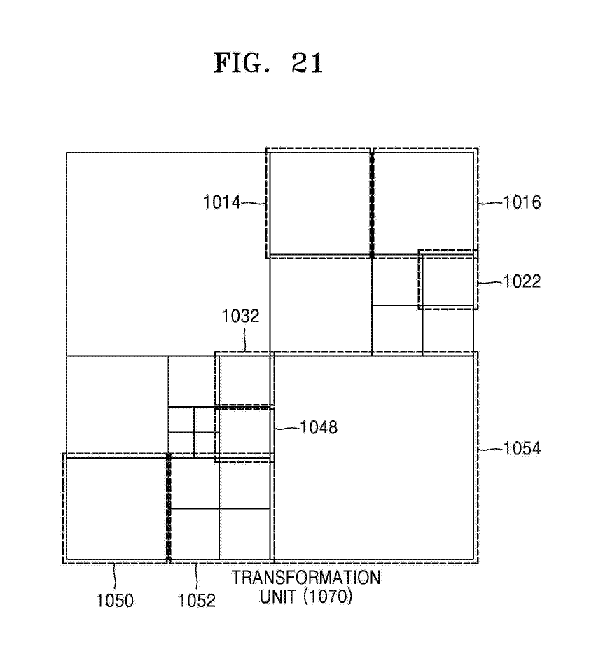

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound output unit, and a microphone 12550 for inputting voice and sound or another type sound input unit. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 27 illustrates an internal structure of the mobile phone 12500. In order to systemically control parts of the mobile phone 12500 including the display screen 12520 and the operation panel 12540, a power supply circuit 12700, an operation input controller 12640, an image encoding unit 12720, a camera interface 12630, an LCD controller 12620, an image decoding unit 12690, a multiplexer/demultiplexer 12680, a recording/reading unit 12670, a modulation/demodulation unit 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the image encoding unit 12720 may generate a digital image signal, and text data of a message may be generated via the operation panel 12540 and the operation input controller 12640. When a digital signal is transmitted to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is converted to a digital sound signal by the sound processor 12650, under control of the central controller 12710. The generated digital sound signal may be converted to a transmission signal through the modulation/demodulation unit 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

In order to transmit image data in the data communication mode, image data captured by the camera 12530 is provided to the image encoding unit 12720 via the camera interface 12630. The captured image data may be directly displayed on the display screen 12520 via the camera interface 12630 and the LCD controller 12620.

A structure of the image encoding unit 12720 may correspond to that of the aforementioned video encoding apparatus of the present disclosure. The image encoding unit 12720 may transform the image data received from the camera 12530 into compressed and encoded image data according to the aforementioned video encoding method of the present disclosure, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoding unit 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from an outer source, frequency recovery and analog-to-digital conversion (ADC) are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 12660 and the sound processor 12650, and the analog sound signal is output via the speaker 12580, under control of the central controller 12710.

In the data communication mode, when data of a video file accessed at an Internet website is received, a signal received from the wireless base station 12000 via the antenna 12510 is output as multiplexed data via the modulation/demodulation unit 12660, and the multiplexed data is transmitted to the multiplexer/demultiplexer 12680.

In order to decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoding unit 12690 may correspond to that of the aforementioned video decoding apparatus of the present disclosure. The image decoding unit 12690 may decode the encoded video data to generate reconstructed video data and may provide the reconstructed video data to the display screen 12520 via the LCD controller 12620, according to the aforementioned video decoding method of the present disclosure.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both the video encoding apparatus and the video decoding apparatus of the present disclosure, may be a transceiving terminal including only the video encoding apparatus of the present disclosure, or may be a transceiving terminal including only the video decoding apparatus of the present disclosure.

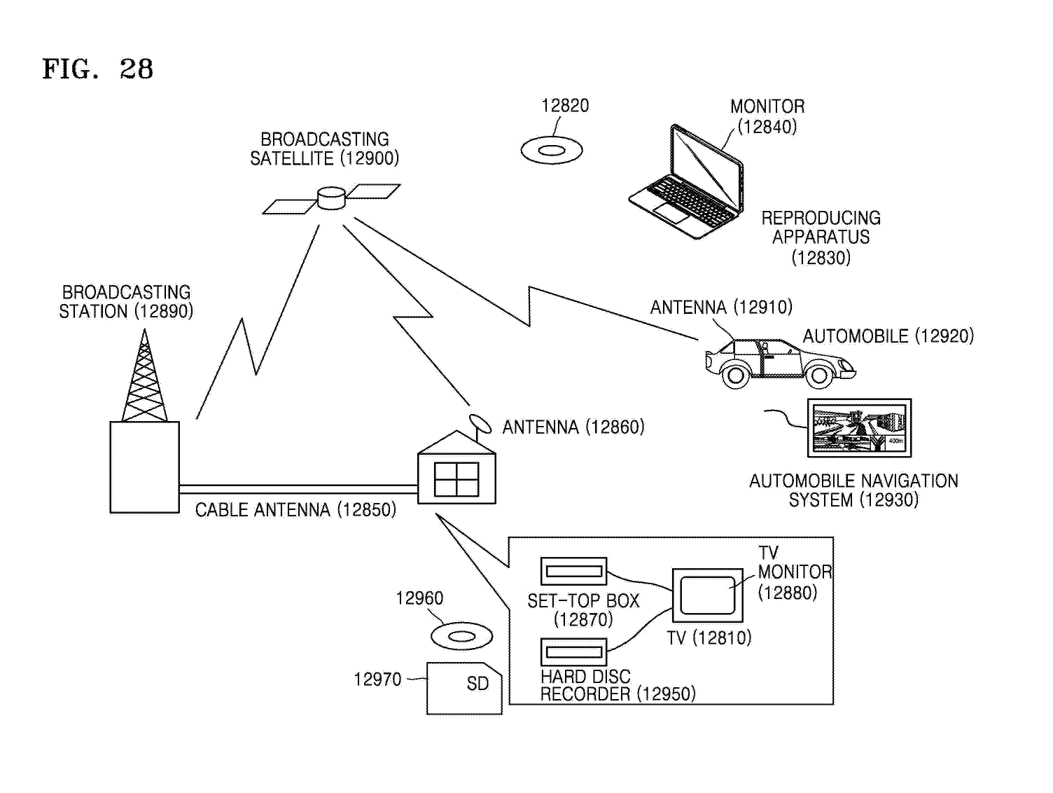

A communication system according to the present disclosure is not limited to the communication system described above with reference to FIG. 26. For example, FIG. 28 illustrates a digital broadcasting system employing a communication system, according to various embodiments. The digital broadcasting system of FIG. 28 according to various embodiments may receive a digital broadcast transmitted via a satellite or a terrestrial network by using the video encoding apparatus and the video decoding apparatus of the present disclosure.

In more detail, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When the video decoding apparatus of the present disclosure is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, the video decoding apparatus of the present disclosure may be installed. Data output from the set-top box 12870 may also be reproduced on a TV monitor 12880.

As another example, the video decoding apparatus of the present disclosure may be installed in the TV receiver 12810 instead of the set-top box 12870.

An automobile 12920 that has an appropriate antenna 12910 may receive a signal transmitted from the satellite 12900 or the wireless base station 11700 of FIG. 23. A decoded video may be reproduced on a display screen of an automobile navigation system 12930 installed in the automobile 12920.

A video signal may be encoded by the video encoding apparatus of the present disclosure and may then be recorded to and stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes the video decoding apparatus of the present disclosure according to various embodiments, a video signal recorded on the DVD disc 12960, the SD card 12970, or another storage medium may be reproduced on the TV monitor 12880.

The automobile navigation system 12930 may not include the camera 12530, the camera interface 12630, and the image encoding unit 12720 of FIG. 28. For example, the computer 12100 and the TV receiver 12810 may not include the camera 12530, the camera interface 12630, and the image encoding unit 12720 of FIG. 28.

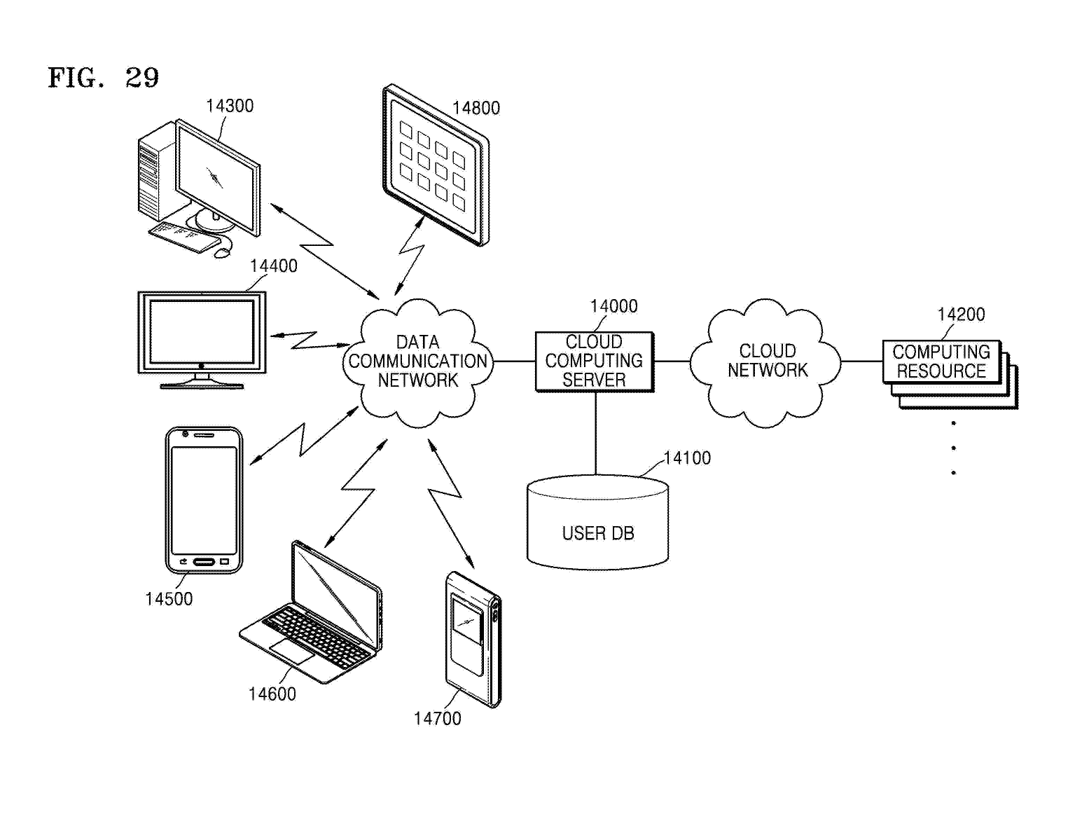

FIG. 29 is a diagram illustrating a network structure of a cloud computing system using a video encoding apparatus and a video decoding apparatus, according to various embodiments.

The cloud computing system of the present disclosure may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a user who uses a specified service is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 29.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include the video decoding apparatus of the present disclosure as described above with reference to FIGS. 1A through 22. As another example, the user terminal may include the video encoding apparatus of the present disclosure as described above with reference to FIGS. 1A through 22. Alternatively, the user terminal may include both the video decoding apparatus and the video encoding apparatus of the present disclosure as described above with reference to FIGS. 1A through 22.

Various applications of the video encoding method, the video decoding method, the video encoding apparatus, and the video decoding apparatus according to various embodiments described above with reference to FIGS. 1A through 22 are described above with reference to FIGS. 23 through 29. However, methods of storing the video encoding method and the video decoding method in a storage medium or methods of implementing the video encoding apparatus and the video decoding apparatus in a device, according to various embodiments, are not limited to the embodiments described above with reference to FIGS. 23 through 29.

It will be understood by one of ordinary skill in the art that various changes in form and details may be made therein without departing from the spirit and scope of the disclosure as defined by the appended claims. The embodiments should be considered in a descriptive sense only and not for purposes of limitation. Therefore, the scope of the disclosure is defined not by the detailed description of the disclosure but by the appended claims, and all differences within the scope will be construed as being included in the present disclosure.

1. A multilayer video decoding method comprising:
obtaining a disparity vector of a current block; and
when a size of the current block is greater than a predetermined block size, splitting the current block into a plurality of regions, based on a region-split shape of a depth block indicated by the disparity vector.

2. The multilayer video decoding method of claim 1, wherein the predetermined block size is one of 4×4, 8×8, 16×16, 32×32, and 64×64.

3. The multilayer video decoding method of claim 1, wherein the splitting of the current block into the plurality of regions comprises splitting the current block into subblocks of the current block, according to the shape by which the depth block is split into a plurality of subblocks.

4-6. (canceled)

7. A multilayer video encoding method comprising:
obtaining a disparity vector of a current block; and
when a size of the current block is greater than a predetermined block size, splitting the current block into a plurality of regions, based on a region-split shape of a depth block indicated by the disparity vector.

8. The multilayer video encoding method of claim 7, wherein the predetermined block size is one of 4×4, 8×8, 16×16, 32×32, and 64×64.

9. The multilayer video encoding method of claim 7, wherein the splitting of the current block into the plurality of regions comprises splitting the current block into subblocks of the current block, according to the shape by which the depth block is split into a plurality of subblocks.

10-12. (canceled)

13. A multilayer video decoding apparatus comprising:
a decoder configured to obtain a disparity vector of a current block, and when a size of the current block is greater than a predetermined block size, to split the current block into a plurality of regions, based on a region-split shape of a depth block indicated by the disparity vector.

14. The multilayer video decoding apparatus of claim 13, wherein the predetermined block size is one of 4×4, 8×8, 16×16, 32×32, and 64×64.

15. The multilayer video decoding apparatus of claim 13, wherein the decoder is further configured to split, when the decoder splits the current block into the plurality of regions, the current block into subblocks of the current block, according to the shape by which the depth block is split into a plurality of subblocks.

16. A multilayer video encoding apparatus comprising:
an encoder configured to obtain a disparity vector of a current block, and when a size of the current block is greater than a predetermined block size, to split the current block into a plurality of regions, based on a region-split shape of a depth block indicated by the disparity vector.

17. The multilayer video encoding apparatus of claim 16, wherein the predetermined block size is one of 4×4, 8×8, 16×16, 32×32, and 64×64.

18. The multilayer video encoding apparatus of claim 16, wherein the encoder is further configured to split, when the encoder splits the current block into the plurality of regions, the current block into subblocks of the current block, according to the shape by which the depth block is split into a plurality of subblocks.

19. A non-transitory computer-readable recording medium having recorded thereon a program for executing the method of claim 1.
